(19) United States
(12) Patent Application Publication
(10) Pub. No.: US 2025/0048341 A1
(43) Pub. Date: Feb. 6, 2025

(54) TERMINAL APPARATUS, BASE STATION APPARATUS, AND COMMUNICATION METHOD

(71) Applicant: Sharp Kabushiki Kaisha, Sakai City, Osaka (JP)

(72) Inventors: Hiroki TAKAHASHI, Sakai City (JP); Shohei YAMADA, Sakai City (JP); Liqing LIU, Sakai City (JP)

(21) Appl. No.: 18/722,436

(22) PCT Filed: Oct. 31, 2022
(86) PCT No.: PCT/JP2022/040706

§ 371 Date: Jun. 20, 2024

(30) Foreign Application Priority Data
Dec. 24, 2021 (JP) 2021-210066

(51) Int. Cl. H04W 72/0446; H04L 5/00; H04W 72/232

(52) U.S. Cl. CPC H04W 72/0446; H04L 5/0053; H04W 72/232

(57) ABSTRACT

A terminal apparatus receives first DCI with an SI-RNTI and receives a SIB in a first time resource in a first BWP, and receives second DCI with an RA-RNTI and receives an RAR in a second time resource in a second BWP, and determines the first time resource, using a first value included in the first DCI and a first configuration, and determines the second time resource, using a second value included in the second DCI and a second configuration. In a case that a second parameter list is provided in the SIB, the terminal apparatus applies the second parameter list to the second configuration. In a case that the second parameter list is not provided, the terminal apparatus applies a first parameter list or a first default table.

### TECHNICAL FIELD

The present invention relates to a terminal apparatus, a base station apparatus, and a communication method.

This application claims priority to JP 2021-210066 filed on Dec. 24, 2021, the contents of which are incorporated herein by reference.

### BACKGROUND ART

Technical studies and standardization of Long Term Evolution (LTE)-Advanced Pro and New Radio (NR) technology, as a radio access scheme and a radio network technology for fifth generation cellular systems, are currently conducted by The Third Generation Partnership Project (3GPP) (NPL 1).

The fifth generation cellular system requires three anticipated scenarios for services: enhanced Mobile BroadBand (eMBB) which realizes high-speed, high-capacity transmission, Ultra-Reliable and Low Latency Communication (URLLC) which realizes low-latency, high-reliability communication, and massive Machine Type Communication (mMTC) that allows a large number of machine type devices to be connected in a system such as Internet of Things (IoT). Furthermore, in Release 17, which is a future release of NR, a reduced capability (REDCAP) NR device that does not require high requirements unlike eMBB and URLLC and achieves cost reduction and long battery life is being studied on the assumption of applications such as sensor networks, monitoring cameras, and/or wearable devices (NPL 2).

### CITATION LIST

### Non Patent Literature

NPL 1: RP-161214, NTT DOCOMO, “Revision of SI: Study on New Radio Access Technology”, June 2016
NPL 2: RP-193238, Ericsson, “New SID on support of reduced capability NR devices”, December 2019

### SUMMARY OF INVENTION

### Technical Problem

An object of the present invention is to provide a terminal apparatus, a base station apparatus, and a communication method that enable efficient communication in a radio communication system as that described above.

### Solution to Problem

(1) In order to accomplish the object described above, an aspect of the present invention is contrived to provide the following means. Specifically, a terminal apparatus according to an aspect of the present invention includes: a receiver configured to, in a first BWP of a first cell, receive first downlink control information (DCI) with a CRC scrambled by an SI-RNTI and receive a system information block (SIB) via a first physical downlink shared channel (PDSCH) scheduled in a first time resource, and configured to, in a second BWP of the first cell, receive second DCI with a CRC scrambled by an RA-RNTI and receive a random access response via a second PDSCH scheduled in a second time resource; and a controller configured to determine the first time resource, using a first value indicated by a first field included in the first DCI and a first PDSCH time domain resource allocation configuration indicating mapping between the first value and a time resource, and determine the second time resource, using a second value indicated by a second field included in the second DCI and a second PDSCH time domain resource allocation configuration indicating mapping between the second value and a time resource. The controller applies a first default table, a second default table, or a third default table to the first PDSCH time domain resource allocation configuration. The controller determines whether a second parameter list is provided in the SIB. In a case that the second parameter list is provided in the SIB, the controller applies the second parameter list to the second PDSCH time domain resource allocation configuration. In a case that the second parameter list is not provided in the SIB, the controller applies a first parameter list or the first default table to the second PDSCH time domain resource allocation configuration.

(2) A base station apparatus according to an aspect of the present invention includes: a transmitter configured to, in a first BWP of a first cell, transmit first downlink control information (DCI) with a CRC scrambled by an SI-RNTI and transmit a system information block (SIB) via a first physical downlink shared channel (PDSCH) scheduled in a first time resource, and configured to, in a second BWP of the first cell, transmit second DCI with a CRC scrambled by an RA-RNTI and transmit a random access response via a second PDSCH scheduled in a second time resource; and a controller configured to determine a first value indicated by a first field included in the first DCI, using the first time resource and a first PDSCH time domain resource allocation configuration indicating mapping between the first value and a time resource, and determine a second value indicated by a second field included in the second DCI, using the second time resource and a second PDSCH time domain resource allocation configuration indicating mapping between the second value and a time resource. The controller applies a first default table, a second default table, or a third default table to the first PDSCH time domain resource allocation configuration. In a case that the second parameter list is provided in the SIB, the controller applies the second parameter list to the second PDSCH time domain resource allocation configuration. In a case that the second parameter list is not provided in the SIB, the controller applies a first parameter list or the first default table to the second PDSCH time domain resource allocation configuration.

(3) A communication method according to an aspect of the present invention is a communication method for a base station apparatus. The communication method includes the steps of: in a first BWP of a first cell, transmitting first downlink control information (DCI) with a CRC scrambled by an SI-RNTI and transmitting a system information block (SIB) via a first physical downlink shared channel (PDSCH) scheduled in a first time resource, and, in a second BWP of the first cell, transmitting second DCI with a CRC scrambled by an RA-RNTI and transmitting a random access response via a second PDSCH scheduled in a second time resource; determining a first value indicated by a first field included in the first DCI, using the first time resource and a first PDSCH time domain resource allocation configuration indicating mapping between the first value and a time resource, and determining a second value indicated by a second field included in the second DCI, using the second time resource and a second PDSCH time domain resource allocation configuration indicating mapping between the second value and the time resource; applying a first default table, a second default table, or a third default table to the first PDSCH time domain resource allocation configuration; in a case that the second parameter list is provided in the SIB, applying the second parameter list to the second PDSCH time domain resource allocation configuration; and in a case that the second parameter list is not provided in the SIB, applying a first parameter list or the first default table to the second PDSCH time domain resource allocation configuration.

### Advantageous Effects of Invention

According to one aspect of the present invention, a terminal apparatus and a base station apparatus can efficiently communicate with each other.

### BRIEF DESCRIPTION OF DRAWINGS

FIG. 1 is a diagram illustrating a concept of a radio communication system according to an embodiment of the present invention.

FIG. 2 is a diagram illustrating an example of a schematic configuration of an uplink and downlink slot according to an embodiment of the present invention.

FIG. 3 is a diagram illustrating a relationship of a subframe, a slot, and a mini-slot in a time domain according to an embodiment of the present invention.

FIG. 4 is a diagram illustrating an example of an SS/PBCH block and an SS burst set according to an embodiment of the present invention.

FIG. 5 is a diagram illustrating resources in which a PSS, an SSS, a PBCH, and a DMRS for the PBCH are mapped in the SS/PBCH block according to an embodiment of the present invention.

FIG. 6 is a diagram illustrating an example of a parameter configuration of an information element BWP-DownlinkCommon of initialDownlinkBWP and separateInitialDownlinkBWP according to an embodiment of the present invention.

FIG. 7 is a diagram illustrating an example of RF retuning according to an embodiment of the present invention.

FIG. 8 is a diagram illustrating an outline related to a frequency location of an additional synchronization signal block according to an embodiment of the present invention.

FIG. 9 is a diagram illustrating an example of PDSCH mapping types according to an embodiment of the present invention.

FIG. 10 is a diagram illustrating an example of a criterion for selecting a resource allocation table to be applied to a PDSCH time domain resource allocation according to an embodiment of the present invention.

FIG. 11 is a diagram illustrating an example of a default table A according to an embodiment of the present invention.

FIG. 12 is a diagram illustrating an example of a default table B according to an embodiment of the present invention.

FIG. 13 is a diagram illustrating an example of a default table C according to an embodiment of the present invention.

FIG. 14 is a diagram illustrating an example of calculation of a SLIV according to an embodiment of the present invention.

FIG. 15 is a flowchart illustrating an example of processing related to reception of DCI, a SIB, and a random access response in a terminal apparatus 1 according to an embodiment of the present invention.

FIG. 16 is a flowchart illustrating an example of processing related to determination/specification/configuration/setting of the resource allocation table to be applied to the PDSCH time domain resource allocation in the terminal apparatus 1 according to an embodiment of the present invention.

FIG. 17 is another flowchart illustrating an example of processing related to determination/specification/configuration/setting of the resource allocation table to be applied to the PDSCH time domain resource allocation in the terminal apparatus 1 according to an embodiment of the present invention.

FIG. 18 is a schematic block diagram illustrating a configuration of the terminal apparatus 1 according to an embodiment of the present invention.

FIG. 19 is a schematic block diagram illustrating a configuration of a base station apparatus 3 according to an embodiment of the present invention.

### DESCRIPTION OF EMBODIMENTS

An embodiment of the present invention will be described below.

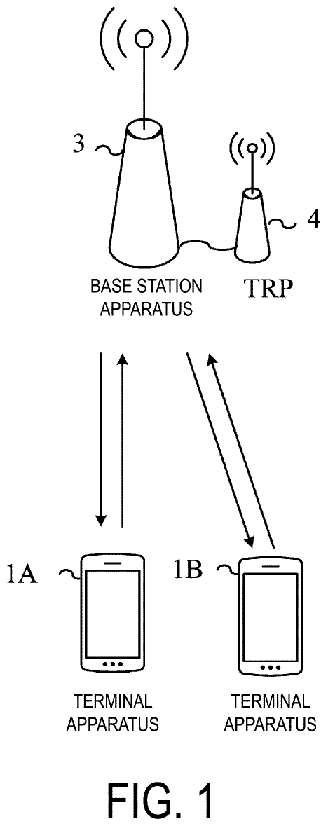

FIG. 1 is a conceptual diagram of a radio communication system according to the present embodiment. In FIG. 1, the radio communication system includes a terminal apparatus 1A, a terminal apparatus 1B, and a base station apparatus 3. The terminal apparatus 1A and the terminal apparatus 1B are also referred to as a terminal apparatus 1 below.

The terminal apparatus 1 is also called a user terminal, a mobile station apparatus, a communication terminal, a mobile device, a terminal, User Equipment (UE), and a Mobile Station (MS). However, the terminal apparatus 1 may be a REDCAP NR device and may be referred to as a REDCAP UE. The base station apparatus 3 is also referred to as a radio base station apparatus, a base station, a radio base station, a fixed station, a Node B (NB), an evolved Node B (eNB), a Base Transceiver Station (BTS), a Base Station (BS), an NR Node B (NR NB), NNB, a Transmission and Reception Point (TRP), or gNB. The base station apparatus 3 may include a core network apparatus. Furthermore, the base station apparatus 3 may include one or multiple transmission reception points 4. At least some of the functions/processing of the base station apparatus 3 described below may be the functions/processing of each of the transmission reception points 4 included in the base station apparatus 3. The base station apparatus 3 may use a communicable range (communication area) controlled by the base station apparatus 3, as one or multiple cells to serve the terminal apparatus 1. Furthermore, the base station apparatus 3 may use a communicable range (communication area) controlled by one or multiple transmission reception points 4, as one or multiple cells to serve the terminal apparatus 1. Additionally, the base station apparatus 3 may divide one cell into multiple beamed areas and serve the terminal apparatus 1 in each of the beamed areas. Here, a beamed area may be identified based on a beam index used for beamforming or a precoding index.

In the present embodiment, a radio communication link from the base station apparatus 3 to the terminal apparatus 1 is referred to as a downlink. In the present embodiment, a radio communication link from the terminal apparatus 1 to the base station apparatus 3 is referred to as an uplink.

In FIG. 1, in a radio communication between the terminal apparatus 1 and the base station apparatus 3, Orthogonal Frequency Division Multiplexing (OFDM) including a Cyclic Prefix (CP), Single-Carrier Frequency Division Multiplexing (SC-FDM), or Discrete Fourier Transform Spread OFDM (DFT-S-OFDM) may be used, or other transmission schemes may be used.

Note that the present embodiment will be described by using OFDM symbols with the assumption that a transmission scheme is OFDM, and use of any other transmission scheme is also included in an aspect of the present invention.

Furthermore, in FIG. 1, in the radio communication between the terminal apparatus 1 and the base station apparatus 3, the CP need not be used, or the above-described transmission scheme with zero padding may be used instead of the CP. Moreover, the CP or zero padding may be added both forward and backward.

An aspect of the present embodiment may be operated in carrier aggregation (CA) or dual connectivity (DC) with the Radio Access Technologies (RAT) such as LTE and LTE-A/LTE-A Pro. In this case, an aspect may be used for some or all of the cells or cell groups, or the carriers or carrier groups (e.g., Primary Cells (PCells), Secondary Cells (SCells), Primary Secondary Cells (PSCells), Master Cell Groups (MCGs), or Secondary Cell Groups (SCGs)). Moreover, an aspect of the present embodiment may be independently operated and used in a stand-alone manner. In the DC operation, the Special Cell (SpCell) is referred to as a PCell of the MCG or a PSCell of the SCG, respectively, depending on whether a Medium Access Control (MAC) entity is associated with the MCG or the SCG. Otherwise, the Special Cell (SpCell) is referred to as a PCell. The Special Cell (SpCell) supports PUCCH transmission and Contention Based Random Access (CBRA).

In the present embodiment, one or multiple serving cells may be configured for the terminal apparatus 1. The multiple serving cells configured may include one primary cell and one or multiple secondary cells. The primary cell may be a serving cell on which an initial connection establishment procedure has been performed, a serving cell in which a connection re-establishment procedure has been initiated, or a cell indicated as a primary cell in a handover procedure. One or multiple secondary cells may be configured at a point of time in a case that or after a Radio Resource Control (RRC) connection is established. Note that the multiple serving cells configured may include one primary secondary cell. The primary secondary cell may be a secondary cell that is included in the one or multiple secondary cells configured and in which the terminal apparatus 1 can transmit control information in the uplink. Additionally, subsets of two types of serving cells corresponding to the MCG and the SCG may be configured for the terminal apparatus 1. The MCG may include one PCell and zero or more SCells. The SCG may include one PSCell and zero or more SCells.

Time Division Duplex (TDD) and/or Frequency Division Duplex (FDD) may be applied to the radio communication system according to the present embodiment. The Time Division Duplex (TDD) scheme or the Frequency Division Duplex (FDD) scheme may be applied to all of the multiple cells. Cells to which the TDD scheme is applied and cells to which the FDD scheme is applied may be aggregated. The TDD scheme may be referred to as an Unpaired spectrum operation. The FDD scheme may be referred to as a Paired spectrum operation.

The subframe will now be described. In the present embodiment, the following is referred to as the subframe, and the subframe in the present embodiment may also be referred to as a resource unit, a radio frame, a time period, or a time interval.

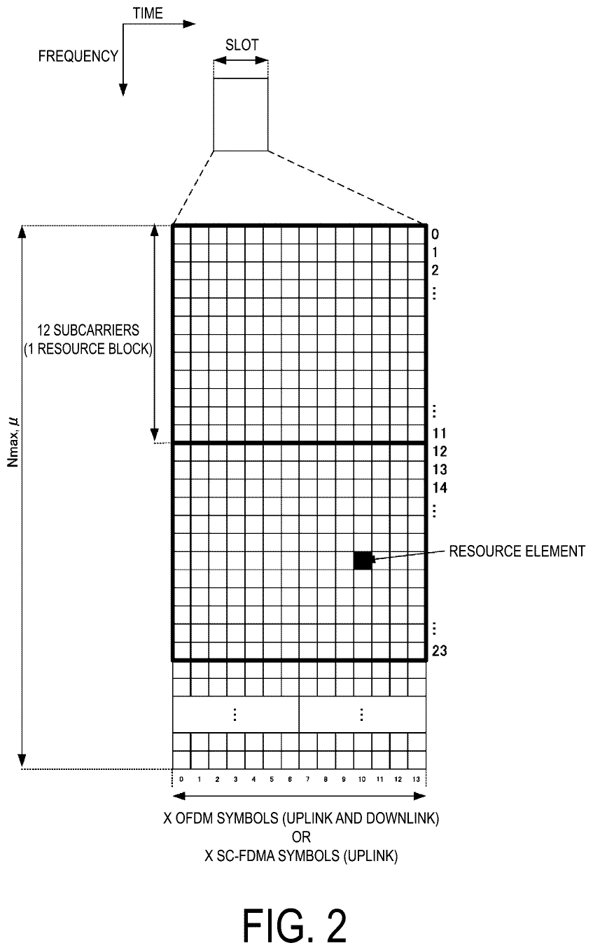

FIG. 2 is a diagram illustrating an example of a schematic configuration of an uplink and downlink slot according to a first embodiment of the present invention. Each of the radio frames is 10 ms in length. Additionally, each of the radio frames includes 10 subframes and W slots. In addition, one slot includes X OFDM symbols. In other words, the length of one subframe is 1 ms. For each of the slots, time length is defined based on subcarrier spacings. For example, in a case that the subcarrier spacing of an OFDM symbol is 15 kHz and Normal Cyclic Prefixes (NCPs) are used, X=7 or X=14, and X=7 and X=14 correspond to 0.5 ms and 1 ms, respectively. In addition, in a case that the subcarrier spacing is 60 kHz, X=7 or X=14, and X=7 and X=14 correspond to 0.125 ms and 0.25 ms, respectively. Additionally, for example, for X=14, W=10 in a case that the subcarrier spacing is 15 kHz, and W=40 in a case that the subcarrier spacing is 60 kHz. FIG. 2 illustrates a case of X=7 as an example. Note that the example in FIG. 2 may be similarly extended also in a case of X=14. Furthermore, the uplink slot is defined similarly, and the downlink slot and the uplink slot may be defined separately. A bandwidth of the cell in FIG. 2 may also be defined as a part band (BandWidth Part (BWP)). However, a BWP used in the downlink may be referred to as a downlink BWP, and a BWP used in the uplink may be referred to as an uplink BWP. In addition, the slot may be referred to as a Transmission Time Interval (TTI). The slot need not be defined as a TTI. The TTI may be a transmission period for transport blocks.

The signal or the physical channel transmitted in each of the slots may be represented by a resource grid. The resource grid is defined by multiple subcarriers and multiple OFDM symbols for each numerology (subcarrier spacing and cyclic prefix length) and for each carrier. The number of subcarriers constituting one slot depends on each of the downlink and uplink bandwidths of a cell. Each element in the resource grid is referred to as a Resource Element (RE). The RE may be identified by using a subcarrier number and an OFDM symbol number.

The resource grid is used to represent mapping of a certain physical downlink channel (such as the PDSCH) or a certain physical uplink channel (such as the PUSCH) to resource elements. For example, for a subcarrier spacing of 15 kHz, in a case that the number X of OFDM symbols included in a subframe is 14 and NCPs are used, one physical resource block (Physical Resource Block (PRB)) is defined by 14 continuous OFDM symbols in the time domain and by 12*Nmax continuous subcarriers in the frequency domain. Nmax represents the maximum number of resource blocks (RBs) determined by a subcarrier spacing configuration μ described below. In other words, the resource grid includes (14*12*Nmax, μ) REs. Extended CPs (ECPs) are supported only at a subcarrier spacing of 60 kHz, and thus one PRB is defined by 12 (the number of OFDM symbols included in one slot)*4 (the number of slots included in one subframe)=48 continuous OFDM symbols in the time domain, and 12* Nmax, μ continuous subcarriers in the frequency domain, for example. In other words, the resource grid includes (48*12*Nmax, μ) REs.

As the RBs, a reference resource block (reference RB), a common resource block (Common RB (CRB)), PRB, and a virtual resource block (Virtual RB (VRB)) are defined. One RB is defined as 12 subcarriers that are continuous in the frequency domain. Reference resource blocks are common to all subcarriers, and for example, resource blocks may be configured at a subcarrier spacing of 15 kHz and may be numbered in ascending order. Subcarrier index 0 at reference resource block index 0 may be referred to as reference point A (point A) (which may simply be referred to as a “reference point”). The point A may be provided as a common reference point for a grid of resource blocks. A location of the point A may be determined/specified by a parameter offsetToPointA included in the SIB1. The parameter offsetToPointA is a parameter indicating a frequency offset between the point A and a subcarrier at the lowest frequency of a resource block at the lowest frequency overlapping with a synchronization signal block used by the terminal apparatus 1 in an initial cell selection. Here, a unit of the frequency offset is a resource block having a subcarrier spacing of 15 kHz for a frequency range (FR) 1, or a resource block having a subcarrier spacing of 60 kHz for a frequency range (FR) 2. Here, the frequency location for the location of the point A may be expressed as ARFCN (Absolute radio-frequency channel number) according to an RRC parameter absoluteFrequencyPointA. The CRB is an RB numbered in ascending order from 0 in each subcarrier spacing configuration μ starting at the point A. Therefore, the CRB number is defined every subcarrier spacing configuration μ. The CRB corresponding to the subcarrier spacing configuration μ may be referred to as a CRB μ. The resource grid described above is defined by the CRB. Here, the center of the subcarrier index 0 of the CRB u of the number 0 in each subcarrier spacing configuration μ is the point A. The PRB is an RB numbered in ascending order from 0 that is included in a BWP of each subcarrier spacing configuration μ, and a PRB is an RB numbered in ascending order from 0 that is included in a BWP that is a subcarrier spacing configuration μ. The PRB corresponding to the subcarrier spacing configuration μ may be referred to as a PRB μ. A certain physical uplink channel is first mapped to a VRB. The VRB is then mapped to a PRB. Hereinafter, an RB may be a VRB, a PRB, a CRB, or a reference resource block.

The BWP is a subset of continuous RBs (which may be CRBs) with a certain subcarrier spacing configuration in a certain carrier. The terminal apparatus 1 may be configured with up to four BWPs (downlink BWPs) in the downlink. There may be one downlink BWP active at a certain time (active downlink BWP). The terminal apparatus 1 may not expect to receive a PDSCH, a PDCCH, or a CSI-RS outside the band of the active downlink BWP. The terminal apparatus 1 may be configured with up to four BWPs (uplink BWPs) in the uplink. There may be one uplink BWP active at a certain time (active uplink BWP). The terminal apparatus 1 transmits neither a PUCCH nor a PUSCH outside the band of the active uplink BWP.

Now, the subcarrier spacing configuration μ will be described. As described above, one or multiple OFDM numerologies are supported in NR. In a certain BWP, the subcarrier spacing configuration μ (μ=0, 1, . . . , 5) and the CP length are given for a downlink BWP by a higher layer and for an uplink BWP by a higher layer. In this regard, given μ, a subcarrier spacing Δf is given by Δf=2\hat{ }μ*15 (kHz).

At the subcarrier spacing configuration μ, the slots are counted in ascending order from 0 to N\hat{ }{subframe, μ}_{slot}−1 within the subframe, and counted in ascending order from 0 to N\hat{ }{frame, μ} _{slot}−1 within the frame. N\hat{ }{slot} _{symb} continuous OFDM symbols are in the slot, based on the slot configuration and the CP. N\hat{ }{slot} _{symb} is 14. The start of the slot n\hat{ }{u} _{s} within the subframe is temporally aligned with the start of the n\hat{ }{n} _{s} *N\hat{ }{slot} _{symb}th OFDM symbol within the same subframe.

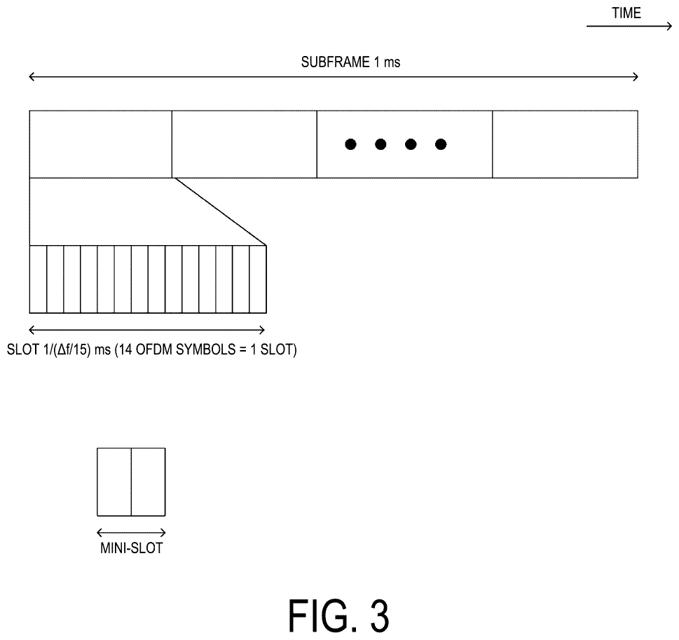

The subframe, the slot, and a mini-slot will now be described. FIG. 3 is a diagram illustrating an example of the relationship between the subframe, the slot, and the mini-slot in the time domain. As illustrated in FIG. 3, three types of time units are defined. The subframe is 1 ms regardless of the subcarrier spacing. The number of OFDM symbols included in the slot is 7 or 14 (but may be 6 or 12 in a case that the CP added to each symbol is an Extended CP), and the slot length depends on the subcarrier spacing. Here, in a case that the subcarrier spacing is 15 kHz, one subframe includes 14 OFDM symbols. The downlink slot may be referred to as PDSCH mapping type A. The uplink slot may be referred to as PUSCH mapping type A.

The mini-slot (which may be referred to as a subslot) is a time unit including OFDM symbols that are less in number than the OFDM symbols included in one slot. FIG. 3 illustrates, by way of example, a case that the mini-slot includes 2 OFDM symbols. The OFDM symbols in the mini-slot may match the timing for the OFDM symbols constituting the slot. Note that the minimum unit of scheduling may be a slot or a mini-slot. Additionally, allocation of mini-slots may be referred to as non-slot based scheduling. Mini-slots being scheduled may also be expressed as resources being scheduled for which the relative time locations of the start positions of the reference signal and the data are fixed. The downlink mini-slot may be referred to as PDSCH mapping type B. The uplink mini-slot may be referred to as PUSCH mapping type B.

In the terminal apparatus 1, a transmission direction (for uplink, downlink, or flexible) of the symbol in each slot is configured by the higher layer using an RRC message including a prescribed higher layer parameter received from the base station apparatus 3 or is configured by a PDCCH in a specific DCI format (for example, DCI format 2_0) received from the base station apparatus 3. In the present embodiment, in each slot, one for configuring each symbol in the slot as uplink, downlink, and flexible is referred to as a slot format. One slot format may include a downlink symbol, an uplink symbol, and a flexible symbol.

A carrier corresponding to the serving cell according to the present embodiment is referred to as a Component Carrier (CC) (or a carrier). In the downlink according to the present embodiment, a carrier corresponding to the serving cell is referred to as a downlink CC (or a downlink carrier). In the uplink according to the present embodiment, a carrier corresponding to the serving cell is referred to as an uplink CC (or an uplink carrier). In the sidelink according to the present embodiment, a carrier corresponding to the serving cell is referred to as a sidelink CC (or a sidelink carrier).

Physical channels and physical signals according to the present embodiment will be described.

In FIG. 1, the following physical channels are used for radio communication between the terminal apparatus 1 and the base station apparatus 3.
Physical Broadcast CHannel (PBCH)
Physical Downlink Control CHannel (PDCCH)
Physical Downlink Shared CHannel (PDSCH)
Physical Uplink Control CHannel (PUCCH)
Physical Uplink Shared CHannel (PUSCH)
Physical Random Access CHannel (PRACH)

The PBCH is used to broadcast essential information block (Master Information Block (MIB), Essential Information Block (EIB), and Broadcast Channel (BCH)) which includes essential system information needed by the terminal apparatus 1. The MIB may include information specifying a number of a radio frame (also referred to as a system frame) (System Frame Number (SFN)) to which the PBCH is mapped, information specifying a subcarrier spacing of a System Information Block type 1 (System Information Block 1 (SIB1)), information indicating a frequency domain offset between a grid of the resource blocks and an SS/PBCH block (also referred to as a synchronization signal block, an SS block, an SSB), and information indicating a configuration related to the PDCCH for the SIB1. Here, the SIB1 includes information necessary for evaluating whether the terminal apparatus 1 is allowed to connect to the cell, and includes information for determining scheduling of other system information (System Information Block (SIB)). Here, the information indicating the configuration related to the PDCCH for the SIB1 may be information for determining a control resource set (ControlResourceSet (CORESET) #0 (CORESET #0 is also referred to as CORESET 0 or common CORESET), a common search space, and/or necessary PDCCH parameters. Here, the CORESET indicates a resource element of the PDCCH, and includes a set of PRBs in a time period of a certain number of OFDM symbols (for example, one to three symbols). The CORESET #0 may be a CORESET for at least a PDCCH scheduling the SIB1. The CORESET #0 may be configured in the MIB or may be configured through RRC signalling. The SIB1 may be scheduled by a PDCCH transmitted in the CORESET #0. The terminal apparatus 1 receives the SIB1 scheduled by the PDCCH received in the CORESET #0. Note that the PDCCH for scheduling the SIB1 may be Downlink Control Information (DCI) with a CRC that is scrambled with a Scheduling information-Radio Network Temporary Identifier (SI-RNTI) transmitted on the PDCCH. The DCI and the SI-RNTI will be described later. On the PDCCH, the terminal apparatus 1 may receive the DCI with the CRC scrambled with the SI-RNTI, and receive the PDSCH including the SIB1 scheduled with the DCI. Note that the PDCCH for scheduling the SIB1 may be the PDCCH with the CRC that is scrambled with the SI-RNTI transmitted on the PDCCH.

The PBCH may be used to broadcast information specifying a number of a radio frame (also referred to as a system frame) (System Frame Number (SFN)) to which the PBCH is mapped and/or information specifying a Half Radio Frame (HRF) (also referred to as a half frame). Here, the half radio frame is a time frame having the 5 ms length, and the information specifying the half radio frame may be information specifying whether the first half 5 ms or the second half 5 ms of the radio frame of 10 ms.

The PBCH may be used to broadcast time indexes within the periodicity of the SS/PBCH blocks. Here, the time index is information indicating the indexes of the synchronization signals and the PBCHs within the cell. The time index may be referred to as an SSB index or an SS/PBCH block index. For example, in a case that the SS/PBCH block is transmitted using the assumption of multiple transmit beams, transmission filter configuration, and/or a Quasi Co-Location (QCL) related a reception spatial parameter, an order of time within a predetermined periodicity or within a configured periodicity may be indicated. Additionally, the terminal apparatus may recognize the difference in time index as a difference in the assumption of the transmit beams, the transmission filter configuration, and/or the Quasi Co-Location (QCL) related the reception spatial parameter.

The PDCCH is used to transmit (or carry) downlink control information in a case of downlink radio communication (radio communication from the base station apparatus 3 to the terminal apparatus 1). Here, one or multiple pieces of DCI (which may be referred to as DCI formats) are defined for transmission of the downlink control information. In other words, a field for the downlink control information is defined as DCI and is mapped to information bits. The PDCCH is transmitted in a PDCCH candidate. The terminal apparatus 1 monitors a set of PDCCH candidates in the serving cell. Here, the monitoring may mean an attempt to decode the PDCCH in accordance with a certain DCI format.

For example, the following DCI format may be defined.
DCI format 0_0
DCI format 0_1
DCI format 0_2
DCI format 1_0
DCI format 1_1
DCI format 1_2
DCI format 2_0
DCI format 2_1
DCI format 2_2
DCI format 2_3

DCI format 0_0 may be used for scheduling of the PUSCH in a certain serving cell. DCI format 0_0 may include information indicating PUSCH scheduling information (frequency domain resource allocation and time domain resource allocation). A Cyclic Redundancy Check (CRC) may be added to DCI format 0_0, the CRC being scrambled with, among Radio Network Temporary Identifiers (RNTIs) being identifiers, any one of a Cell-RNTI (C-RNTI), a Configured Scheduling (CS)-RNTI), an MCS-C-RNTI, and/or a Temporary C-NRTI (TC-RNTI). DCI format 0_0 may be monitored in a common search space or a UE-specific search space.

DCI format 0_1 may be used for scheduling of the PUSCH in a certain serving cell. DCI format 0_1 may include information indicating the PUSCH scheduling information (frequency domain resource allocation and time domain resource allocation), information indicating the BWP, a Channel State Information (CSI) request, a Sounding Reference Signal (SRS) request, and/or information related to antenna ports. A CRC scrambled with any one of RNTIs including the C-RNTI, the CS-RNTI, a Semi Persistent (SP)-CSI-RNTI, and/or the MCS-C-RNTI may be added to DCI format 0_1. DCI format 0_1 may be monitored in the UE-specific search space.

DCI format 0_2 may be used for scheduling of the PUSCH in a certain serving cell. DCI format 0_2 may include information indicating the PUSCH scheduling information (frequency domain resource allocation and time domain resource allocation), information indicating the BWP, a CSI request, an SRS request, and/or information related to the antenna ports. A CRC scrambled with any one of RNTIs including the C-RNTI, the CSI-RNTI, the SP-CSI-RNTI, and/or the MCS-C-RNTI may be added to DCI format 0_2. DCI format 0_2 may be monitored in the UE-specific search space. DCI format 0_2 may be referred to as a DCI format 0_1A or the like.

DCI format 1_0 may be used for scheduling of the PDSCH in a certain serving cell. DCI format 1_0 may include information indicating PDSCH scheduling information (frequency domain resource allocation and time domain resource allocation). A CRC scrambled with any one of identifiers including the C-RNTI, the CS-RNTI, the MCS-C-RNTI, a Paging RNTI (P-RNTI), a System Information (SI)-RNTI, a Random access (RA)-RNTI, and/or the TC-RNTI may be added to DCI format 1_0. DCI format 1_0 may be monitored in the common search space or the UE-specific search space.

DCI format 1_1 may be used for scheduling of the PDSCH in a certain serving cell. DCI format 1_1 may include information indicating the PDSCH scheduling information (frequency domain resource allocation and time domain resource allocation), information indicating the BWP, Transmission Configuration Indication (TCI), and/or information related to the antenna ports. A CRC scrambled with any one of RNTIs including the C-RNTI, the CS-RNTI, and/or the MCS-C-RNTI may be added to DCI format 1_1. DCI format 1_1 may be monitored in the UE-specific search space.

DCI format 1_2 may be used for scheduling of the PDSCH in a certain serving cell. DCI format 1_2 may include information indicating PDSCH scheduling information (frequency domain resource allocation and time domain resource allocation), information indicating the BWP, TCI, and/or information related to the antenna ports. A CRC scrambled with any one of RNTIs including the C-RNTI, the CS-RNTI, and/or the MCS-C-RNTI may be added to DCI format 1_2. DCI format 1_2 may be monitored in the UE-specific search space. DCI format 1_2 may be referred to as DCI format 1_1A or the like.

DCI format 2_0 is used to provide notification of the slot format of one or multiple slots. The slot format is defined as a format in which each OFDM symbol in the slot is classified as downlink, flexible, or uplink. For example, in a case that the slot format is 28, DDDDDDDDDDDDFU is applied to the 14 OFDM symbols in the slot for which slot format 28 is indicated. Here, D is a downlink symbol, F is a flexible symbol, and U is an uplink symbol. Note that the slot will be described below.

DCI format 2_1 is used to notify the terminal apparatus 1 of PRB (or RB) and OFDM symbols which may be assumed to involve no transmission. Note that this information may be referred to as a pre-emption indication (intermittent transmission indication).

DCI format 2_2 is used for transmission of the PUSCH and a Transmit Power Control (TPC) command for the PUSCH.

DCI format 2_3 is used to transmit a group of TPC commands for transmission of sounding reference signals (SRSs) by one or multiple terminal apparatuses 1. Additionally, the SRS request may be transmitted along with the TPC command. In addition, the SRS request and the TPC command may be defined in DCI format 2_3 for uplink with no PUSCH and PUCCH or uplink in which the transmit power control for the SRS is not associated with the transmit power control for the PUSCH.

Here, the DCI for the downlink is also referred to as downlink grant or downlink assignment. Here, the DCI for the uplink is also referred to as uplink grant or Uplink assignment. The DCI may also be referred to as a DCI format.

CRC parity bits added to the DCI format transmitted on one PDCCH are scrambled with the SI-RNTI, the P-RNTI, the C-RNTI, the CS-RNTI, the RA-RNTI, or the TC-RNTI. The SI-RNTI may be an identifier used for broadcasting of the system information. The P-RNTI may be an identifier used for paging and notification of system information modification. The C-RNTI, the MCS-C-RNTI, and the CS-RNTI are identifiers for identifying a terminal apparatus within a cell. The TC-RNTI is an identifier for identifying the terminal apparatus 1 that has transmitted a random access preamble during the CBRA.

The C-RNTI is used to control the PDSCH or the PUSCH in one or multiple slots. The CS-RNTI is used to periodically allocate a resource for the PDSCH or the PUSCH. The MCS-C-RNTI is used to indicate the use of a prescribed MCS table for grant-based transmission. The TC-RNTI is used to control PDSCH transmission or PUSCH transmission in one or multiple slots. The TC-RNTI is used to schedule re-transmission of a random access message 3 and transmission of a random access message 4. The RA-RNTI is determined in accordance with frequency and time location information regarding the physical random access channel on which the random access preamble has been transmitted.

For the C-RNTI and/or the other RNTIs, different values corresponding to the type of traffic on the PDSCH or the PUSCH may be used. For the C-RNTI and the other RNTIs, different values corresponding to the service type (eMBB, URLLC, and/or mMTC) of the data transmitted on the PDSCH or PUSCH may be used. The base station apparatus 3 may use the RNTI having a different value corresponding to the service type of the data transmitted. The terminal apparatus 1 may identify the service type of the data transmitted on the associated PDSCH or PUSCH, based on the value of the RNTI applied to the received DCI (used for the scrambling).

The PUCCH is used to transmit Uplink Control Information (UCI) in a case of uplink radio communication (radio communication from the terminal apparatus 1 to the base station apparatus 3). Here, the uplink control information may include Channel State Information (CSI) used to indicate a downlink channel state. The uplink control information may include a Scheduling Request (SR) used to request an UL-SCH resource. The uplink control information may include a Hybrid Automatic Repeat request ACKnowledgement (HARQ-ACK). The HARQ-ACK may indicate a HARQ-ACK for downlink data (Transport block, Medium Access Control Protocol Data Unit (MAC PDU), or Downlink-Shared CHannel (DL-SCH)).

The PDSCH is used to transmit downlink data (Downlink Shared CHannel (DL-SCH)) from a Medium Access Control (MAC) layer. In a case of the downlink, the PDSCH is also used to transmit System Information (SI), paging information, a Random Access Response (RAR), and the like.

The PUSCH may be used to transmit uplink data (Uplink-Shared CHannel (UL-SCH)) from the MAC layer or to transmit the HARQ-ACK and/or CSI along with the uplink data. The PUSCH may be used to transmit CSI only or a HARQ-ACK and CSI only. In other words, the PUSCH may be used to transmit the UCI only.

Here, the base station apparatus 3 and the terminal apparatus 1 exchange (transmit and/or receive) signals with each other in higher layers. For example, the base station apparatus 3 and the terminal apparatus 1 may transmit and/or receive an RRC message (also referred to as RRC information or RRC signalling) in a Radio Resource Control (RRC) layer. In a Medium Access Control (MAC) layer, the base station apparatus 3 and the terminal apparatus 1 may transmit and/or receive a MAC control element. Additionally, the RRC layer of the terminal apparatus 1 acquires system information broadcast from the base station apparatus 3. In this regard, the RRC message, the system information, and/or the MAC control element are also referred to as higher layer signaling or a higher layer parameter. Each of the parameters included in the higher layer signaling received by the terminal apparatus 1 may be referred to as a higher layer parameter. The higher layer as used herein means a higher layer as viewed from the physical layer, and thus may include one or multiple of the MAC layer, the RRC layer, an RLC layer, a PDCP layer, a Non Access Stratum (NAS) layer, and the like. For example, in the processing of the MAC layer, the higher layer may include one or multiple of the RRC layer, the RLC layer, the PDCP layer, the NAS layer, and the like. Hereinafter, “A is given (provided) in the higher layer” or “A is given (provided) by the higher layer” may mean that the higher layer (mainly the RRC layer, the MAC layer, or the like) of the terminal apparatus 1 receives A from the base station apparatus 3, and that the received A is given (provided) from the higher layer of the terminal apparatus 1 to the physical layer of the terminal apparatus 1. For example, “a higher layer parameter being provided” in the terminal apparatus 1 may mean that higher layer signaling is received from the base station apparatus 3, and a higher layer parameter included in the received higher layer signaling is provided from the higher layer of the terminal apparatus 1 to the physical layer of the terminal apparatus 1. A higher layer parameter being configured for the terminal apparatus 1 may mean that the higher layer parameter is given (provided) to the terminal apparatus 1. For example, a higher layer parameter being configured for the terminal apparatus 1 may mean that the terminal apparatus 1 receives higher layer signaling from the base station apparatus 3 and configures the received higher layer parameter in the higher layer. However, a higher layer parameter being configured for the terminal apparatus 1 may include a default parameter given in advance being configured in the higher layer of the terminal apparatus 1.

The PDSCH or the PUSCH may be used to transmit the RRC signalling and the MAC control element. The RRC signalling transmitted on the PDSCH from the base station apparatus 3 may be signaling common to multiple terminal apparatuses 1 in a cell. The RRC signalling transmitted from the base station apparatus 3 may be dedicated signaling for a certain terminal apparatus 1 (also referred to as dedicated signaling). In other words, terminal apparatus-specific (UE-specific) information may be transmitted through dedicated signaling to the certain terminal apparatus 1. Additionally, the PUSCH may be used to transmit UE capabilities in the uplink.

In FIG. 1, the following downlink physical signals are used for downlink radio communication. Here, the downlink physical signals are not used to transmit information output from the higher layers but are used by the physical layer.
Synchronization signal (SS)
Reference Signal (RS)

The synchronization signal may include a Primary Synchronization Signal (PSS) and a Secondary Synchronization Signal (SSS). A cell ID may be detected by using the PSS and SSS.

The synchronization signal is used for the terminal apparatus 1 to establish synchronization in a frequency domain and a time domain in the downlink. Here, the synchronization signal may be used for the terminal apparatus 1 to select precoding or a beam in precoding or beamforming performed by the base station apparatus 3. Note that the beam may be referred to as a transmission or reception filter configuration, or a spatial domain transmission filter or a spatial domain reception filter.

A reference signal is used for the terminal apparatus 1 to perform channel compensation on a physical channel. Here, the reference signal is used for the terminal apparatus 1 to calculate the downlink CSI. Furthermore, the reference signal may be used for a numerology such as a radio parameter or subcarrier spacing, or used for Fine synchronization that allows FFT window synchronization to be achieved.

According to the present embodiment, at least one of the following downlink reference signals are used.
Demodulation Reference Signal (DMRS)
Channel State Information Reference Signal (CSI-RS)
Phase Tracking Reference Signal (PTRS)
Tracking Reference Signal (TRS)

The DMRS is used to demodulate a modulated signal. Note that two types of reference signals may be defined as the DMRS: a reference signal for demodulating the PBCH and a reference signal for demodulating the PDSCH or that both reference signals may be referred to as the DMRS. The CSI-RS is used for measurement of Channel State Information (CSI) and beam management, and a transmission method for a periodic, semi-persistent, or aperiodic CSI reference signal is applied to the CSI-RS. For the CSI-RS, a Non-Zero Power (NZP) CSI-RS and a CSI-RS with zero transmit power (or receive power) (Zero Power (ZP)) may be defined. Here, the ZP CSI-RS may be defined as a CSI-RS resource that has zero transmit power or that is not transmitted. The PTRS is used to track phase on the time axis to ensure frequency offset caused by phase noise. The TRS is used to ensure Doppler shift during fast movement. Note that the TRS may be used as one configuration of the CSI-RS. For example, a radio resource may be configured with the CSI-RS for one port as a TRS.

According to the present embodiment, one or multiple of the following uplink reference signals are used.
Demodulation Reference Signal (DMRS)
Phase Tracking Reference Signal (PTRS)
Sounding Reference Signal (SRS)

The DMRS is used to demodulate a modulated signal. Note that two types of reference signals may be defined as the DMRS: a reference signal for demodulating the PUCCH and a reference signal for demodulating the PUSCH or that both reference signals may be referred to as the DMRS. The SRS is used for measurement of uplink channel state information (CSI), channel sounding, and beam management. The PTRS is used to track phase on the time axis to ensure frequency offset caused by phase noise.

In the present embodiment, the downlink physical channel and/or the downlink physical signal are collectively referred to as a downlink signal. In the present embodiment, the uplink physical channel and/or the uplink physical signal are collectively referred to as an uplink signal. In the present embodiment, the downlink physical channel and/or the uplink physical channel are collectively referred to as a physical channel. In the present embodiment, the downlink physical signal and/or the uplink physical signal are collectively referred to as a physical signal.

The BCH, the UL-SCH, and the DL-SCH are transport channels. A channel used in the Medium Access Control (MAC) layer is referred to as a transport channel. A unit of the transport channel used in the MAC layer is also referred to as a transport block (TB) and/or a MAC Protocol Data Unit (PDU). A Hybrid Automatic Repeat reQuest (HARQ) is controlled for each transport block in the MAC layer. The transport block is a unit of data that the MAC layer delivers to the physical layer. In the physical layer, the transport block is mapped to a codeword, and encoding processing is performed for each codeword.

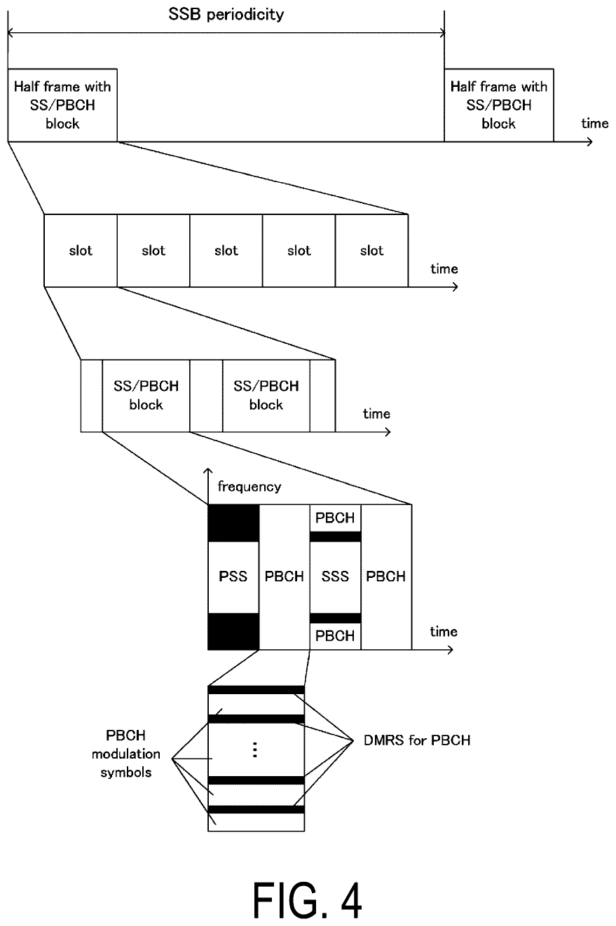

FIG. 4 is a diagram illustrating an example of SS/PBCH blocks (also referred to as synchronization signal blocks, SS blocks, and SSBs) and half frames (which may be referred to as Half frame with SS/PBCH block or SS burst sets) in which one or more SS/PBCHs are transmitted according to the present embodiment. FIG. 4 illustrates an example in which two SS/PBCH blocks are included in the SS burst set present with a certain periodicity (which may be referred to as an SSB periodicity), and the SS/PBCH block includes continuous four OFDM symbols.

The SS/PBCH block may be a block including a synchronization signal (PSS, SSS), a PBCH, and a DMRS for the PBCH. However, the SS/PBCH block may be a block including a synchronization signal (PSS and SSS), a REDCAP PBCH, and a DMRS for the REDCAP PBCH. Transmitting the signals/channels included in the SS/PBCH block is described as transmitting the SS/PBCH block. In a case of transmitting the synchronization signals and/or the PBCHs using one or multiple SS/PBCH blocks in the SS burst set, the base station apparatus 3 may use an independent downlink transmit beam for each SS/PBCH block.

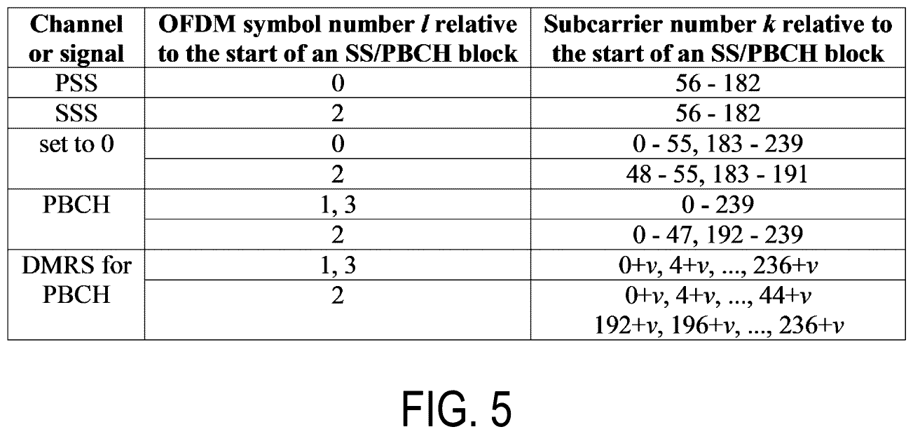

In FIG. 4, the PSS, the SSS, the PBCH and the DMRS for the PBCH are time/frequency multiplexed in one SS/PBCH block. FIG. 5 is a table illustrating resources in which a PSS, an SSS, a PBCH, and a DMRS for the PBCH are mapped in the SS/PBCH block.

The PSS may be mapped to the first symbol in the SS/PBCH block (an OFDM symbol having an OFDM symbol number of 0 relative to a start symbol of the SS/PBCH block). A PSS sequence may include 127 symbols and may be mapped to the 57th subcarrier to the 183rd subcarrier in the SS/PBCH block (subcarriers having subcarrier numbers of 56 to 182 relative to a start subcarrier of the SS/PBCH block).

The SSS may be mapped to the third symbol in the SS/PBCH block (the OFDM symbol having the OFDM symbol number of 2 relative to the start symbol of the SS/PBCH block). An SSS sequence may include 127 symbols and may be mapped to the 57th subcarrier to the 183rd subcarrier in the SS/PBCH block (the subcarriers having the subcarrier numbers of 56 to 182 relative to the start subcarrier of the SS/PBCH block).

The PBCH and the DMRS may be mapped to the second, third, and fourth symbols in the SS/PBCH block (the OFDM symbols having the OFDM symbol numbers of 1, 2, and 3 relative to the start symbol of the SS/PBCH block). A PBCH modulation symbol sequence may include Msymb symbols and may be mapped to resources to which no DMRS is mapped among the first subcarrier to the 240th subcarrier of the second and fourth symbols in the SS/PBCH block (the subcarriers having the subcarrier numbers of 0 to 239 relative to the start subcarrier of the SS/PBCH block) and the first subcarrier to the 48th subcarrier and the 184th to the 240th subcarrier of the third symbol in the SS/PBCH block (the subcarriers having the subcarrier numbers of 0 to 47 and 192 to 239 relative to the start subcarrier of the SS/PBCH block). A DMRS symbol sequence may include 144 symbols and may be mapped to the first subcarrier to the 240th subcarrier of the second and fourth symbols in the SS/PBCH block (the subcarriers having the subcarrier numbers of 0 to 239 relative to the start subcarrier of the SS/PBCH block) and the first subcarrier to the 48th subcarrier and the 184th to the 240th subcarrier of the third symbol in the SS/PBCH block (the subcarriers having the subcarrier numbers of 0 to 47 and 192 to 239 relative to the start subcarrier of the SS/PBCH block), in which one subcarrier is mapped every four subcarriers. For example, for 240 subcarriers, the PBCH modulation symbols may be mapped to 180 subcarriers, and the DMRS for the PBCH may be mapped to 60 subcarriers.

A different SS/PBCH block in the SS burst set may be assigned with a different SSB index. An SS/PBCH block assigned with an SSB index may be periodically transmitted based on the SSB periodicity by the base station apparatus 3. For example, the SSB periodicity for the SS/PBCH block to be used for an initial access and the SSB periodicity configured for the connected (Connected or RRC_Connected) terminal apparatus 1 may be defined. Furthermore, the SSB periodicity configured for the connected (Connected or RRC_Connected) terminal apparatus 1 may be configured using RRC parameters. Additionally, the SSB periodicity configured for the connected (Connected or RRC_Connected) terminal apparatus 1 may be a periodicity of a radio resource in the time domain during which transmission is potentially to be performed, and in practice, whether the transmission is to be performed may be determined by the base station apparatus 3. Furthermore, the SSB periodicity for the SS/PBCH block to be used for the initial access may be predefined in specifications or the like. For example, the terminal apparatus 1 performing the initial access may regard the SSB periodicity as 20 milliseconds.

A time location of the SS burst set to which the SS/PBCH block is mapped may be specified based on the information specifying the System Frame Number (SFN) and/or the information specifying the half frame included in the PBCH. The terminal apparatus 1 receiving the SS/PBCH block may specify the current system frame number and half frame based on the received SS/PBCH block.

The SS/PBCH block is assigned with the SSB index (which may be referred to as the SS/PBCH block index) depending on the temporal position in the SS burst set. The terminal apparatus 1 specifies the SSB index based on the information of the PBCH and/or information of the reference signal included in the detected SS/PBCH block.

The SS/PBCH blocks with the same relative time in each SS burst set in the multiple SS burst sets may be assigned with the same SSB index. The SS/PBCH blocks with the same relative time in each SS burst set in the multiple SS burst sets may be assumed to be QCLed (or the same downlink transmit beam may be assumed to be applied to these SS/PBCH blocks). In addition, antenna ports in the SS/PBCH blocks with the same relative time in each SS burst set in the multiple SS burst sets may be assumed to be QCLed for average delay, Doppler shift, and spatial correlation.

Within a certain SS burst set periodicity, the SS/PBCH block assigned with the same SSB index may be assumed to be QCLed for average delay, average gain, Doppler spread, Doppler shift, and spatial correlation. A configuration corresponding to one or multiple SS/PBCH blocks (or the SS/PBCH blocks may be reference signals) that are QCLed may be referred to as a QCL configuration.

The number of SS/PBCH blocks (which may be referred to as the number of SS blocks or the SSB number) may be defined as, for example, the number of SS/PBCH blocks within an SS burst, an SS burst set, or an SS/PBCH block periodicity. Additionally, the number of SS/PBCH blocks may indicate the number of beam groups for cell selection within the SS burst, the SS burst set, or the SS/PBCH block periodicity. Here, the beam group may be defined as the number of different SS/PBCH blocks or the number of different beams included in the SS burst, the SS burst set, or the SS/PBCH block periodicity (SSB periodicity).

The SS/PBCH blocks with the same relative time in each SS burst set in the multiple SS burst sets may be assigned with the same SSB index. The SS/PBCH blocks with the same relative time in each SS burst set in the multiple SS burst sets may be assumed to be QCLed (or the same downlink transmit beam may be assumed to be applied to these SS/PBCH blocks). In addition, antenna ports in the SS/PBCH blocks with the same relative time in each SS burst set in the multiple SS burst sets may be assumed to be QCLed for average delay, Doppler shift, and spatial correlation.

Within a certain SS burst set periodicity, the SS/PBCH block assigned with the same SSB index may be assumed to be QCLed for average delay, average gain, Doppler spread, Doppler shift, and spatial correlation.

An initial BWP, an initial downlink BWP (initial DL BWP), and an initial uplink BWP (initial UL BWP) according to the present embodiment may be a BWP, a downlink BWP, and an uplink BWP used at the time of the initial access before the RRC connection is established, respectively. However, the initial BWP, the initial downlink BWP, and the initial uplink BWP may be used after the RRC connection is established. However, each of the initial BWP, the initial downlink BWP, and the initial uplink BWP may be a BWP having an index of 0 (#0), a downlink BWP having an index of 0 (#0), and an uplink BWP having an index of 0 (#0).

The initial downlink BWP may be configured using a parameter provided in the MIB, a parameter provided in the SIB1, a parameter provided in the SIB, and/or an RRC parameter. For example, the initial downlink BWP may be configured by a parameter initialDownlinkBWP included in a parameter downlinkConfigCommon provided in the SIB1. For example, the SIB1 (or another SIB) may be transmitted including downlinkConfigCommonRedCap. In this case, the initial downlink BWP may be configured by the parameter initialDownlinkBWP included in the parameter downlinkConfigCommonRedCap provided in the SIB1 (or another SIB). However, initialDownlinkBWP may be a parameter indicating a UE-specific, dedicated) configuration of the initial downlink BWP.

The SIB1 may be transmitted including downlinkConfigCommon being a common downlink configuration parameter of a cell. At least one of the parameters for the terminal apparatus 1 in a cell to determine whether or not the cell is barred may be included in downlinkConfigCommon indicating the common downlink parameter of the cell. The parameter downlinkConfigCommon may include a parameter indicating a basic parameter related to one downlink carrier and transmission in the corresponding cell (e.g., referred to as frequencyInfoDL) and a parameter indicating a configuration of a first initial downlink BWP of a serving cell (e.g., referred to as initialDownlinkBWP).

The SIB1 may be transmitted including downlinkConfigCommonRedCap being a common downlink configuration parameter of a cell. The downlinkConfigCommonRedCap may include a parameter (for example, referred to as separateInitialDownlinkBWP) indicating a configuration of a second initial downlink BWP (which may be referred to as a separate initial downlink BWP) of a serving cell. Note that separateInitialDownlinkBWP included in downlinkConfigCommonRedCap may be referred to as initialDownlinkBWP, and have the same information element configuration as initialDownlinkBWP included in downlinkConfigCommon. Note that separateInitialDownlinkBWP may be included in downlinkConfigCommon. Note that separateInitialDownlinkBWP may be included in a SIB other than the SIB1 and/or an RRC parameter. Note that separateInitialDownlinkBWP may be a parameter including a part or all of the parameter configuration of initialDownlinkBWP included in downlinkConfigCommon, and each parameter may be configuration information for the second initial downlink BWP (which may be the separate initial downlink BWP). The second initial downlink BWP may be referred to as a second downlink BWP.

In a case that separateInitialDownlinkBWP is included in downlinkConfigCommonRedCap, the terminal apparatus 1 may specify/configure/determine the separate initial downlink BWP, based on parameters included in the separateInitialDownlinkBWP. Note that the separate initial downlink BWP may be referred to as an initial downlink BWP. For example, in a case that the terminal apparatus 1 receives separateInitialDownlinkBWP (which may be initialDownlinkBWP included in downlinkConfigCommonRedCap) in the SIB1, the terminal apparatus 1 may specify/configure/determine the initial downlink BWP, based on the parameters of the separateInitialDownlinkBWP. The initial downlink BWP specified/configured/determined with initialDownlinkBWP in downlinkConfigCommon may be referred to as the first initial downlink BWP, and the initial downlink BWP specified/configured/determined with separateInitialDownlinkBWP in downlinkConfigCommonRedCap may be referred to as the second initial downlink BWP.

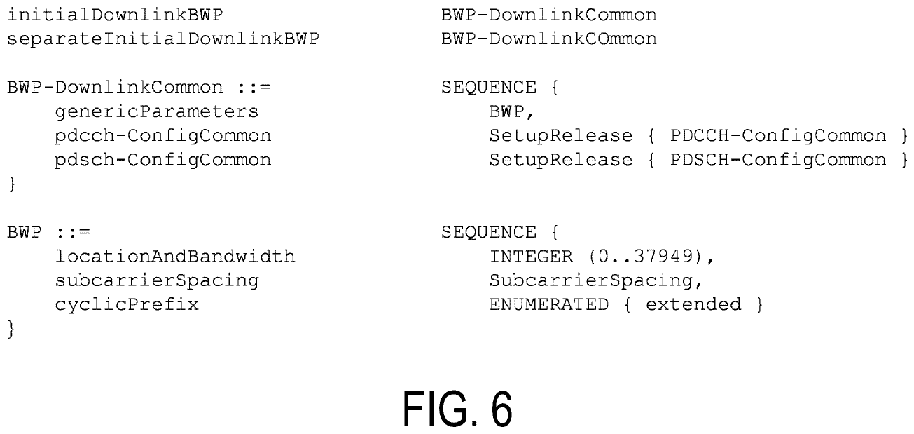

FIG. 6 illustrates an example of a parameter configuration of an Information Element (IE) BWP-DownlinkCommon of initialDownlinkBWP and separateInitialDownlinkBWP according to the present embodiment. initialDownlinkBWP and separateInitialDownlinkBWP according to the present embodiment may include generic parameters genericParameters of the initial downlink BWP, a cell-specific parameter pdcch-ConfigCommon of the PDCCH, a cell-specific parameter pdsch-ConfigCommon of the PDSCH, and/or other parameters. The information element BWP-DownlinkCommon of separateInitialDownlinkBWP may be referred to as BWP-DownlinkCommonRedCap. genericParameters, pdcch-ConfigCommon, and pdsch-ConfigCommon included in separateInitialDownlinkBWP may be referred to as genericParametersRedCap, pdcch-ConfigCommonRedCap, and pdsch-ConfigCommonRedCap, respectively.

In a case that the multiple initial downlink BWPs are configured by multiple initialDownlinkBWPs/separateInitialDownlinkBWPs in a cell (or in a case that the configuration information of multiple frequency locations and/or multiple bandwidths for the initial downlink BWP is broadcast in a cell), a part of the information included in genericParameters in initialDownlinkBWP may be a parameter common to the multiple initial downlink BWPs (or the configuration information of multiple frequency locations and/or multiple bandwidths of the initial downlink BWP).

The information element BWP of the parameter genericParameters may be parameters indicating a frequency location and a bandwidth of a corresponding BWP. The information element BWP may include a parameter subcarrierSpacing indicating a subcarrier spacing used in the corresponding BWP, a parameter locationAndBandwidth indicating a location and a bandwidth in the frequency domain (the (total) number of resource blocks) of the corresponding BWP, and/or a parameter cyclicPrefix indicating whether a standard cyclic prefix (CP) or an extended CP is used in the corresponding BWP. That is, the corresponding BWP may be defined by the subcarrier spacing, the CP, and the location and the bandwidth in the frequency domain. However, a value indicated by locationAndBandwidth may be interpreted as a Resource Indicator Value (RIV). The resource indicator value indicates a starting PRB index of the corresponding BWP and the number of continuous PRBs. However, the first PRB defining a field of the resource indicator value may be a PRB determined by a subcarrier spacing given by subcarrierSpacing of the corresponding BWP and offsetToCarrier configured using SCS-SpecificCarrier included in FrequencyInfoDL (or FrequencyInfoDL-SIB) or FrequencyInfoUL (or FrequencyInfoUL-SIB) corresponding to the subcarrier spacing. Also, a size defining the field of the resource indicator value may be 275. The subcarrier spacing of the initial downlink BWP indicated by subcarrierSpacing included in genericParameters in initialDownlinkBWP may be configured to be the same value as the subcarrier spacing indicated by the MIB of the same cell. In a case that cyclicPrefix is not included (not set) in genericParameters, the terminal apparatus 1 may use the standard CP without using the extended CP.

The parameter frequencyInfoDL may include frequencyBandList indicating a list of one or more frequency bands to which the downlink carriers belong and a list of SCS-SpecificCarrier indicating a set of parameters related to the carriers per subcarrier spacing. The parameter frequencyInfoUL may include a frequency BandList indicating a list of one or more frequency bands to which the uplink carriers belong and a list of SCS-SpecificCarrier indicating a set of parameters related to the carriers per subcarrier spacing.

The parameter SCS-SpecificCarrier may include parameters indicating actual locations and bandwidths of the carriers and the bandwidths of the carriers. To be more specific, the information element SCS-SpecificCarrier in frequencyInfoDL indicates a configuration for a specific carrier and includes subcarrierSpacing, carrierbandwidth and/or offsetToCarrier. The parameter subcarrierSpacing is a parameter indicating the subcarrier spacing of the carrier (for example, indicating 15 kHz or 30 kHz in FR1, and indicating 60 kHz or 120 kHz in FR2). The parameter carrierbandwidth is a parameter indicating the bandwidth of the carrier by the number of Physical Resource Blocks (PRBs). The parameter offsetToCarrier is a parameter indicating an offset in the frequency domain between the reference point A (the lowest subcarrier of a common RB0) and the lowest usable subcarrier of the carrier in number of PRBs (where the subcarrier spacing is a subcarrier spacing of the carrier given in subcarrierSpacing). For example, for a downlink carrier, a bandwidth of the downlink carrier is given by a higher layer parameter carrierbandwidth in SCS-SpecificCarrier in frequencyInfoDL per subcarrier spacing, and a start position on a frequency of the downlink carrier is given by the parameter offsetToCarrier in SCS-SpecificCarrier in frequencyInfoDL per subcarrier spacing. For example, for an uplink carrier, a bandwidth of the uplink carrier is given by a higher layer parameter carrierbandwidth in SCS-SpecificCarrier in frequencyInfoUL per subcarrier spacing, and a start position on a frequency of the uplink carrier is given by the parameter offsetToCarrier in SCS-SpecificCarrier in frequencyInfoUL per subcarrier spacing.

In a case that neither initialDownlinkBWP nor separateInitialDownlinkBWP is provided (configured) in the SIB1 (which may be another SIB or an RRC parameter) received by the terminal apparatus 1 (which may be a case that initialDownlinkBWP is not provided (configured) in either downlinkConfigCommon or downlinkConfigCommonRedCap in the SIB1 received by the terminal apparatus 1), the terminal apparatus 1 may determine/specify the initial downlink BWP with the position and the number of continuous PRBs starting from a PRB (physical resource block) with the lowest index and ending at a PRB with the highest index among the PRBs of the CORESET for Type0-PDCCH CSS Set (such as CORESET #0), and the SubCarrier Spacing (SCS) and the cyclic prefix of the PDCCH received in the CORESET for Type0-PDCCH CSS Set. In a case that initialDownlinkBWP (which may be separateInitialDownlinkBWP) is provided in downlinkConfigCommonRedCap in the SIB1 received by the terminal apparatus 1, the terminal apparatus 1 may determine/specify the initial downlink BWP with the initialDownlinkBWP. In a case that initialDownlinkBWP (which may be separateInitialDownlinkBWP) is not provided/configured in downlinkConfigCommonRedCap in the SIB1 received by the terminal apparatus 1, initialDownlinkBWP is provided/configured in downlinkConfigCommon in the SIB1 received by the terminal apparatus 1, and the terminal apparatus 1 supports the bandwidth of the BWP configured by the initialDownlinkBWP, the terminal apparatus 1 may determine/specify the initial downlink BWP with the initialDownlinkBWP. In a case that initialDownlinkBWP (which may be separateInitialDownlinkBWP) is not provided/configured in downlinkConfigCommonRedCap in the SIB1 received by the terminal apparatus 1, initialDownlinkBWP is provided/configured in downlinkConfigCommon in the SIB1 received by the terminal apparatus 1, and the terminal apparatus 1 does not support the bandwidth of the BWP configured by the initialDownlinkBWP, the terminal apparatus 1 may determine/specify the initial downlink BWP with the position and the number of continuous PRBs starting from a PRB (physical resource block) with the lowest index and ending at a PRB with the highest index among the PRBs of the CORESET for Type0-PDCCH CSS Set (such as CORESET #0), and the SubCarrier Spacing (SCS) and the cyclic prefix of the PDCCH received in the CORESET for Type0-PDCCH CSS Set.

However, the state in which initialDownlinkBWP is provided by downlinkConfigCommon may be a state in which initialDownlinkBWP is received in the RRC parameter and an RRC connection is established (for example, RRCSetup, RRCResume, and/or RRCReestablishment is received). For example, in a case that the terminal apparatus 1 receives initialDownlinkBWP in downlinkConfigCommon in the SIB1, the terminal apparatus 1 may consider the CORESET #0 as the initial downlink BWP until receiving RRCSetup, RRCResume, or RRCReestablishment. However, considering the CORESET #0 as the initial downlink BWP may be determining/specifying the initial downlink BWP by the position and the number of continuous PRBs starting from a PRB with the lowest index and ending at a PRB with the highest index among the PRBs of the CORESET #0. However, determining/specifying the initial downlink BWP may mean determining/specifying the frequency location and/or the bandwidth of the initial downlink BWP. In the case that the terminal apparatus 1 receives initialDownlinkBWP in downlinkConfigCommon in the SIB1, after receiving RRCSetup, RRCResume, and/or RRCReestablishment, the terminal apparatus 1 may determine/specify the initial downlink BWP using locationAndBandwidth included in the received initialDownlinkBWP after receiving RRCSetup, RRCResume, and/or RRCReestablishment. In the case that the terminal apparatus 1 receives initialDownlinkBWP in the SIB1, the terminal apparatus 1 may specify the initial downlink BWP using the CORESET #0 until the RRC connection is established, and may determine/specify the initial downlink BWP using locationAndBandwidth included in initialDownlinkBWP after the RRC connection is established.

Note that the state in which initialDownlinkBWP (which may be separateInitialDownlinkBWP) is provided in downlinkConfigCommonRedCap may be a state in which initialDownlinkBWP is received in an RRC parameter. For example, in a case that the terminal apparatus 1 receives initialDownlinkBWP in downlinkConfigCommonRedCap in the SIB1, the terminal apparatus 1 may determine/specify the initial downlink BWP with locationAndBandwidth included in received initialDownlinkBWP.

RRCSetup may be a message the terminal apparatus 1 receives from the base station apparatus 3 (which may be a network) in a case that the terminal apparatus 1 transmits an RRCSetupRequest message to the base station apparatus 3 (which may be a network). The base station apparatus 3 (which may be a network) may transmit an RRCSetup message to the terminal apparatus 1 in a case that the RRC connection is established between the base station apparatus 3 and the terminal apparatus 1.

RRCResume may be a message the terminal apparatus 1 receives from the base station apparatus 3 (which may be a network) in a case that the terminal apparatus 1 transmits an RRCResumeRequest message or an RRCResumeRequest1 message to the base station apparatus 3 (which may be a network). The base station apparatus 3 (which may be a network) may transmit an RRCResume message to the terminal apparatus 1 in a case that the base station apparatus 3 resumes the RRC connection with the terminal apparatus 1.

RRCReestablishment may be a message the terminal apparatus 1 receives from the base station apparatus 3 (which may be a network) in a case that the terminal apparatus 1 transmits an RRCReestablishmentRequest message to the base station apparatus 3 (which may be a network). The base station apparatus 3 (which may be a network) may transmit an RRCReestablishment message to the terminal apparatus 1 in a case that the RRC connection is re-established between the base station apparatus 3 and the terminal apparatus 1.

The initial uplink BWP may be configured using a parameter provided in the MIB, a parameter provided in the SIB1, a parameter provided in the SIB, or an RRC parameter. For example, the initial uplink BWP may be configured using a parameter initialUplinkBWP provided in the SIB1. However, initialUplinkBWP is a parameter indicating a UE-specific, dedicated) configuration of the initial uplink BWP.

The initial uplink BWP may be defined/configured in initialUplinkBWP provided in the SIB1 (which may be the REDCAP SIB1, another SIB, or an RRC parameter). The terminal apparatus 1 may determine the initial uplink BWP based on initialUplinkBWP provided by the received SIB1. For example, the terminal apparatus 1 may specify the configuration of the initial uplink BWP, such as the frequency location and the subcarrier spacing, with the parameters included in initialUplinkBWP provided by the received SIB1.

The terminal apparatus 1 includes an RF circuit between an antenna included in the terminal apparatus 1 itself and a signal processing unit processing a baseband signal. The RF circuit mainly includes a signal processing unit, a power amplifier, an antenna switch, a filter, and the like. The signal processing unit of the RF circuit, in a case of receiving signals, performs processing of demodulating the RF signal received via the filter to output the received signal to the signal processing unit. The high frequency signal processing unit of the RF circuit, in a case of transmitting signals, performs processing of modulating a carrier signal to generate an RF signal, amplifying power by the power amplifier, and then outputting the RF signal to the antenna. The antenna switch connects the antenna and the filter in a case of receiving signals, and connects the antenna and the power amplifier in a case of transmitting signals.

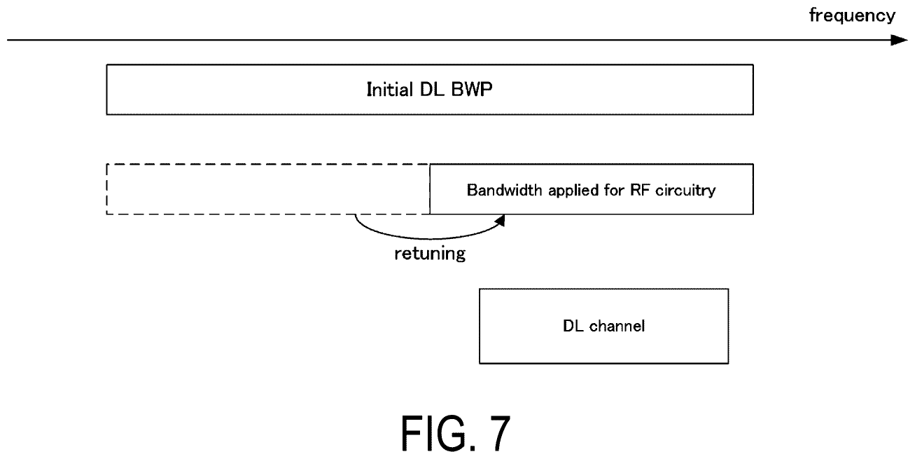

In a case that the bandwidth of the configured initial downlink BWP is wider than the bandwidth supported by the RF circuit included in the terminal apparatus 1 (which may be referred to as an allocation bandwidth), the terminal apparatus 1 may tune/retune the frequency band applied to the RF circuit in the initial downlink BWP. Tuning/retuning the frequency band applied to the RF circuit may be referred to as RF tuning/RF retuning. FIG. 7 is a diagram illustrating an example of RF retuning. In FIG. 7, in a case that the applied band of the RF circuit used in the terminal apparatus 1 is outside the band of the downlink channel received in the initial downlink BWP, the terminal apparatus 1 performs RF retuning so that the applied band of the RF circuit includes the band of the downlink channel to be received. In a case that the bandwidth of the configured initial uplink BWP is wider than the bandwidth supported by the RF circuit included in the terminal apparatus 1 (which may be referred to as an allocation bandwidth), the terminal apparatus 1 may tune/retune the frequency band applied to the RF circuit in the initial uplink BWP. In a case that the bandwidth of the configured downlink BWP is wider than the bandwidth supported by the RF circuit included in the terminal apparatus 1 (which may be referred to as an allocation bandwidth), the terminal apparatus 1 may tune/retune the frequency band applied to the RF circuit in the downlink BWP. In a case that the bandwidth of the configured initial uplink BWP is wider than the bandwidth supported by the RF circuit included in the terminal apparatus 1 (which may be referred to as an allocation bandwidth), the terminal apparatus 1 may tune/retune the frequency band applied to the RF circuit in the uplink BWP.

The terminal apparatus 1 according to an aspect of the present invention receives/specifies configuration information of the initial downlink BWP with the higher layer parameter initialDownlinkBWP in downlinkConfigCommon or the higher layer parameter initialDownlinkBWP in downlinkConfigCommonRedCap. However, the parameter initialDownlinkBWP may be included in the SIB1 or may be included in any RRC message. For example, the configuration information of the initial downlink BWP may include information indicating the frequency location and bandwidth of the initial downlink BWP. The terminal apparatus 1 may receive the SIB1 or any RRC signalling including multiple pieces of the configuration information of the initial downlink BWP. Multiple pieces of the configuration information of the initial downlink BWP may be included in one parameter initialDownlinkBWP.

pdcch-ConfigCommon that may be included in initialDownlinkBWP in downlinkConfigCommon and pdcch-ConfigCommon (which may be referred to as pdcch-ConfigCommonRedCap) that may be included in initialDownlinkBWP in downlinkConfigCommonRedCap may include a parameter controlResourceSetZero of the CORESET #0 used in a common search space or a UE-specific search space, a parameter commonControlResourceSet of an additional common CORESET used in a common search space or a UE-specific search space, a parameter searchSpaceZero of a common search space 0 (common search space #0), a parameter commonSearchSpaceList indicating a list of common search spaces other than the common search space 0, a parameter searchSpaceSIB1 indicating an ID of a search space for a SIB1 messages, a parameter searchSpaceOtherSystemInformation indicating an ID of a search space for other system information, a parameter pagingSearchSpace indicating an ID of a search space for paging, and/or a parameter ra-SearchSpace indicating an ID of a search space for a random access procedure, in a corresponding initial downlink BWP. Note that pdcch-ConfigCommon (pdcch-ConfigCommonRedCap) that may be included in initialDownlinkBWP in downlinkConfigCommonRedCap may invariably not include controlResourceSetZero.

Any value from 0 to 15 is configured for an Information Element (IE) ControlResourceSetZero indicated by controlResourceSetZero. However, the number of values that can be configured for ControlResourceSetZero may be other than 16, and may be 32, for example. Any one of values 0 to 15 is configured for an information element SearchSpaceZero indicated by searchSpaceZero. However, the number of values that can be configured for SearchSpaceZero may be other than 16, and may be 32, for example.

The terminal apparatus 1 determines the number of continuous resource blocks and the number of continuous symbols for the CORESET #0 from controlResourceSetZero in pdcch-ConfigCommon. However, the value indicated by controlResourceSetZero is applied to a prescribed table as an index. However, the terminal apparatus 1 may determine the table for the application based on the supported UE category and/or UE Capability. However, the terminal apparatus 1 may determine the table for the application based on the minimum channel bandwidth. However, the terminal apparatus 1 may determine the table for the application based on the subcarrier spacing of the SS/PBCH block and/or the subcarrier spacing of the CORESET #0. Each row of the table to which the value of controlResourceSetZero is applied as an index may indicate the index indicated by controlResourceSetZero, a multiplexing pattern of the PBCH and the CORESET, the number of RBs (which may be PRBs) of the CORESET #0, the number of symbols of the CORESET #0, the offset and/or the number of PDCCH repetitions.

commonSearchSpaceList is a parameter indicating a list of additional common search spaces (CSSs), and configures common search spaces having search space IDs other than 0. A parameter SearchSpace included in commonSearchSpaceList at least includes a parameter searchSpaceId indicating a search space ID used for specifying the search space, and may further include a parameter controlResourceSetId indicating a CORESET ID used for specifying one CORESET in the serving cell.

searchSpaceSIB1 includes an information element SearchSpaceId indicating an ID of a search space for a SIB1 message. The terminal apparatus 1 may specify the CSS used for monitoring the PDCCH for scheduling the PDSCH including a SIB1 message from the ID of the search space indicated by searchSpaceSIB1 and the list of common search spaces indicated by commonSearchSpaceList, and further specify the CORESET used for monitoring the PDCCH for scheduling the SIB1 message and the configuration (for example, the frequency location) of the CORESET.

searchSpaceOtherSystemInformation includes an information element SearchSpaceId indicating an ID of a search space for other system information (OSI). The terminal apparatus 1 may specify the CSS used for monitoring the PDCCH for scheduling the PDSCH including OSI from the ID of the search space indicated by searchSpaceOtherSystemInformation and the list of common search spaces indicated by commonSearchSpaceList, and further specify the CORESET used for monitoring the PDCCH for scheduling the PDSCH including the OSI and the configuration (for example, the frequency location) of the CORESET.

pagingSearchSpace includes an information element SearchSpaceId indicating an ID of a search space for paging. The terminal apparatus 1 may specify the CSS used for monitoring the PDCCH for scheduling the PDSCH including paging information from the ID of the search space indicated by pagingSearchSpace and the list of common search spaces indicated by commonSearchSpaceList, and further specify the CORESET used for monitoring the PDCCH for scheduling the PDSCH including the paging information and the configuration (for example, the frequency location) of the CORESET.

ra-SearchSpace includes an information element SearchSpaceId indicating an ID of a search space for a random access procedure. The terminal apparatus 1 may specify the CSS used for monitoring the PDCCH for scheduling the PDSCH including a random access response (RAR) from the ID of the search space indicated by ra-SearchSpace and the list of common search spaces indicated by commonSearchSpaceList, and further specify the CORESET used for monitoring the PDCCH for scheduling the PDSCH including the RAR and the configuration (for example, the frequency location) of the CORESET.

The multiplexing pattern of the PBCH and the CORESET indicates a pattern of a relationship between the SS/PBCH block corresponding to the PBCH in which the MIB is detected and the frequency/time location of the corresponding CORESET #0. For example, in a case that the multiplexing pattern of the PBCH and the CORESET is 1, the PBCH and the CORESET #0 are time-multiplexed on different symbols.

The number of RBs of the CORESET #0 indicates the number of resource blocks continuously allocated to the CORESET #0. The number of symbols of the CORESET #0 indicates the number of symbols continuously allocated to the CORESET #0.

The offset indicates an offset from the lowest RB index of the resource block allocated to the CORESET #0 to the lowest RB index of the common resource block overlapped by the first resource block of the corresponding REDCAP PBCH. However, the offset may indicate an offset from the lowest RB index of the resource block allocated to the CORESET #0 to the lowest RB index of the common resource block overlapped by the first resource block of the corresponding SS/PBCH blocks.

The terminal apparatus 1 receives initialDownlinkBWP (or separateInitialDownlinkBWP) including the RRC parameter pdcch-ConfigCommon using the SIB1, another SIB1, or the RRC signalling, and monitors the PDCCH based on the parameter.

The terminal apparatus 1 determines a PDCCH monitoring occasion from searchSpaceZero in pdcch-ConfigCommon. However, a value indicated by the searchSpaceZero is applied to a prescribed table as an index. However, the terminal apparatus 1 may determine the table for the application based on the supported UE category and/or UE Capability. However, the terminal apparatus 1 may determine the table for the application based on the frequency range.

The terminal apparatus 1 monitors the PDCCH in a Type0-PDCCH common search space set (Type0-PDCCH CSS Set) over two continuous slots from a slot n0. In the SS/PBCH block having an index of i, the terminal apparatus 1 determines n0 and the system frame number based on a parameter O and a parameter M indicated in the table.

In a case that parameters (locationAndBandwidth in initialDownlinkBWP in downlinkConfigCommon and locationAndBandwidth in separateInitialDownlinkBWP in downlinkConfigCommonRedCap) indicating multiple “frequency locations and bandwidths” for multiple initial downlink BWPs are configured in a cell (which may be a case that multiple initial downlink BWPs are configured in a cell), pdcch-ConfigCommon that may be included in initialDownlinkBWP in downlinkConfigCommon or each parameter of the pdcch-ConfigCommon may be a cell-specific parameter of the PDCCH in the initial downlink BWP configured in initialDownlinkBWP in downlinkConfigCommon, or may be a cell-specific parameter of the PDCCH in common to the initial downlink BWP configured in initialDownlinkBWP in downlinkConfigCommon and the initial downlink BWP configured in separateInitialDownlinkBWP in downlinkConfigCommonRedCap.

pdsch-ConfigCommon (which may be referred to as PDSCH-ConfigCommon) that may be included in initialDownlinkBWP in downlinkConfigCommon and pdsch-ConfigCommon (which may be referred to as PDSCH-ConfigCommon, pdsch-ConfigCommonRedCap, or PDSCH-ConfigCommonRedCap) that may be included in separateInitialDownlinkBWP in downlinkConfigCommonRedCap may include a parameter pdsch-TimeDomainAllocationList indicating a list of time domain configurations for timing of downlink allocation to downlink data.

In a case that the parameters (locationAndBandwidth in initialDownlinkBWP in downlinkConfigCommon and locationAndBandwidth in separateInitialDownlinkBWP in downlinkConfigCommonRedCap) indicating multiple “frequency locations and bandwidths” for the initial downlink BWP are configured in a cell (which may be a case that multiple initial downlink BWPs are configured in a cell), pdsch-ConfigCommon that may be included in initialDownlinkBWP in downlinkConfigCommon or each parameter of the pdsch-ConfigCommon may be a cell-specific parameter of the PDSCH in the initial downlink BWP configured in initialDownlinkBWP in downlinkConfigCommon, or may be a cell-specific parameter of the PDSCH in common to the initial downlink BWP configured in initialDownlinkBWP in downlinkConfigCommon and the initial downlink BWP configured in separateInitialDownlinkBWP in downlinkConfigCommonRedCap.

The terminal apparatus 1 that does not support the frequency location and/or the bandwidth of the initial downlink BWP (first initial downlink BWP) configured in initialDownlinkBWP in downlinkConfigCommon can specify/determine the initial downlink BWP (second initial downlink BWP) configured in separateInitialDownlinkBWP in downlinkConfigCommonRedCap that may be included in the SIB1 (which may be another SIB or RRC signalling), and can thereby receive a downlink channel and a downlink signal transmitted from the base station apparatus 3.

In a case that the base station apparatus 3 configures the initial downlink BWP of the frequency location and/or the bandwidth not supported by a specific terminal apparatus 1 using locationAndBandwidth in downlinkConfigCommon, the base station apparatus 3 can configure the initial downlink BWP of the frequency location and/or the bandwidth supported by the terminal apparatus 1 using locationAndBandwidth in downlinkConfigCommonRedCap, and can thereby appropriately transmit a downlink channel and a downlink signal. The base station apparatus 3 can include locationAndBandwidth in downlinkConfigCommonRedCap in the SIB1 (which may be another SIB or RRC signalling) to transmit the downlink channel and the reference signal corresponding to the second initial downlink BWP to the terminal apparatus 1 not supporting the frequency location and/or the bandwidth of the first initial downlink BWP, and transmit the downlink channel and the reference signal corresponding to the first initial downlink BWP to the terminal apparatus 1 supporting the frequency location and the bandwidth of the first initial downlink BWP. In a case that the base station apparatus 3 configures the initial downlink BWP of the frequency locations and/or the bandwidths supported by all the terminal apparatuses 1 using locationAndBandwidth in initialDownlinkBWP, the base station apparatus 3 may not include locationAndBandwidth in downlinkConfigCommonRedCap in the SIB1 (which may be another SIB or RRC signalling).

The terminal apparatus 1 may determine/specify the subcarrier spacing used for all channels and reference signals in the initial downlink BWP using subcarrierSpacing included in genericParameters in initialDownlinkBWP in downlinkConfigCommon regardless of whether or not locationAndBandwidth is included in downlinkConfigCommonRedCap in the SIB1 (which may be another SIB or RRC signalling). The terminal apparatus 1 may determine/specify whether or not the extended cyclic prefix CP is used in the initial downlink BWP using cyclicPrefix included in genericParameters in initialDownlinkBWP in downlinkConfigCommon regardless of whether or not locationAndBandwidth is included in downlinkConfigCommonRedCap in the SIB1 (which may be another SIB or RRC signalling).

The terminal apparatus 1 may specify/determine a cell-specific parameter for the PDCCH in the initial downlink BWP and monitor/receive the PDCCH using pdcch-ConfigCommon included in initialDownlinkBWP in downlinkConfigCommon regardless of whether or not locationAndBandwidth is included in downlinkConfigCommonRedCap in the SIB1 (which may be another SIB or RRC signalling). The terminal apparatus 1 may specify/determine a cell-specific parameter for the PDSCH in the initial downlink BWP and receive the PDSCH using pdsch-ConfigCommon included in initialDownlinkBWP in downlinkConfigCommon regardless of whether or not locationAndBandwidth is included in downlinkConfigCommonRedCap in the SIB1 (which may be another SIB or RRC signalling).

In a case that the terminal apparatus 1 receives locationAndBandwidth included in downlinkConfigCommonRedCap in the SIB1 (which may be another SIB) and determines the frequency location and bandwidth of the initial downlink BWP (which may be referred to as the separate initial downlink BWP) based on locationAndBandwidth, the terminal apparatus 1 may consider the CORESET #0 as the initial downlink BWP until the RRC connection is established, re-established or resumed (for example, before receiving RRCSetup, RRCResume or RRCReestablishment), and may determine/specify the initial downlink BWP using locationAndBandwidth included in downlinkConfigCommonRedCap in the received SIB1 (which may be another SIB) after the RRC connection is established. However, in the case of considering the CORESET #0 as the initial downlink BWP until the RRC connection is established, re-established, or resumed, the terminal apparatus 1 may perform the random access procedure using the initial downlink BWP determined/specified using the CORESET #0.

In the case that the terminal apparatus 1 receives locationAndBandwidth included in downlinkConfigCommonRedCap in the SIB1 (which may be another SIB) and determines the frequency location and bandwidth of the initial downlink BWP (which may be referred to as the separate initial downlink BWP) based on locationAndBandwidth, the terminal apparatus 1 may consider the CORESET #0 as the initial downlink BWP until receiving the SIB1 (which may be another SIB), and may determine/specify the initial downlink BWP using locationAndBandwidth included in downlinkConfigCommonRedCap in the received SIB1 (which may be another SIB) after receiving the SIB1. However, in a case of determining/specifying the initial downlink BWP using locationAndBandwidth in downlinkConfigCommonRedCap at a point of time in the case of receiving the SIB1 (which may be another SIB), the terminal apparatus 1 may perform the random access procedure using the initial downlink BWP determined/specified using the locationAndBandwidth.

The terminal apparatus 1 may switch the timing of determining/specifying the initial downlink BWP (which may be referred to as the separate initial downlink BWP) based on locationAndBandwidth included in downlinkConfigCommonRedCap in the SIB1 (which may be another SIB) based on the information included in the SIB1. A parameter initialBwpTiming indicating the timing of applying locationAndBandwidth included in downlinkConfigCommonRedCap in the SIB1 (which may be another SIB) may be 1-bit information.

In a certain cell, in a case that the SIB1 is received in a certain initial downlink BWP (first initial downlink BWP), in a case that a separate initial downlink BWP (second initial downlink BWP) having a frequency location and/or a bandwidth different from the first initial downlink BWP is configured, a band of the separate initial downlink BWP may not include a synchronization signal block transmitted in a band of the first initial downlink BWP. In a case that a signal serving as a synchronization signal block is required in the separate initial downlink BWP for paging, random access and/or other applications, an additional synchronization signal block (hereinafter referred to as additional SSB) may be transmitted in the band of the separate initial downlink BWP. The base station apparatus 3 may transmit the additional synchronization signal block in the band of the second initial downlink BWP (the separate initial downlink BWP) specified/determined using locationAndBandwidth in downlinkConfigCommonRedCap. The terminal apparatus 1 may receive the additional synchronization signal block transmitted in the band of the separate initial downlink BWP specified/determined from locationAndBandwidth in downlinkConfigCommonRedCap. The additional synchronization signal block may be a synchronization signal block (referred to as a Non-Cell Defining SSB (NCD-SSB)) that is not a synchronization signal block defining a cell (referred to as a Cell Defining SSB (CD-SSB)). For example, the additional synchronization signal block may not have a center frequency at a Synchronization Raster.

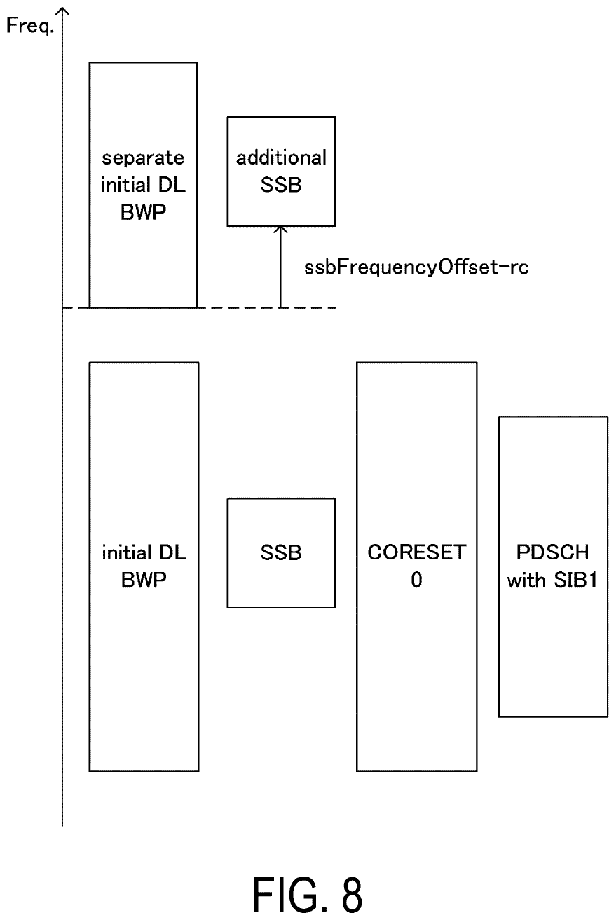

FIG. 8 is a diagram illustrating an outline of the frequency location of the additional synchronization signal block according to the present embodiment. In FIG. 8, in a certain cell, two initial downlink BWPs of an initial downlink BWP (initial DL BWP) and a separate initial downlink BWP (separate initial DL BWP) are configured. However, the initial downlink BWP may be in a band of the CORESET #0. In FIG. 8, the initial downlink BWP includes at least a synchronization signal block (SSB), a CORESET #0, and a PDSCH including a SIB1 (PDSCH with SIB1) in a band. In FIG. 8, the separate initial downlink BWP includes at least an additional synchronization signal block (additional SSB) in a band. The terminal apparatus 1 that receives the synchronization signal block specifies a frequency location of the CORESET #0, and specifies a frequency location and time location of the PDSCH including the SIB1 by the PDCCH received in the CORESET #0. The terminal apparatus 1 that receives the PDSCH including the SIB1 specifies/determines a frequency location (including a bandwidth) of the separate initial downlink BWP, using the parameter locationAndBandwidth included in downlinkConfigCommonRedCap in the SIB1 (which may be another SIB specified by the SIB1, alternatively). The terminal apparatus 1 specifying/determining the frequency location of the separate initial downlink BWP may specify/determine a frequency location of the additional synchronization signal block transmitted in the separate initial downlink BWP, using the parameter ssbFrequencyOffset-rc included in downlinkConfigCommonRedCap in the SIB1 (which may be another SIB specified by the SIB1, alternatively) to receive the additional synchronization signal block.

By detecting the PDCCH including DCI format 1_0, DCI format 1_1, or DCI format 1_2, the terminal apparatus 1 may decode (receive) the corresponding PDSCH. The corresponding PDSCH is scheduled (indicated) by the DCI format (DCI). The start position (starting symbol) of the scheduled PDSCH is referred to as S. The starting symbol S of the PDSCH may be the first symbol in which the PDSCH is transmitted (mapped) within a certain slot. The starting symbol S corresponds to the beginning of the slot. For example, in a case that S has a value of 0, the terminal apparatus 1 may receive the PDSCH from the first symbol in the certain slot. Additionally, for example, in a case that S has a value of 2, the terminal apparatus 1 may receive the PDSCH from the third symbol of the certain slot. The number of continuous (Consecutive) symbols of the scheduled PDSCH is referred to as L. The number of continuous symbols L is counted from the starting symbol S. The determination of S and L allocated to the PDSCH will be described later.

The type of PDSCH mapping includes PDSCH mapping type A and PDSCH mapping type B. For the PDSCH mapping type A, S takes a value ranging from 0 to 3. L takes a value ranging from 3 to 14. However, the sum of S and L takes a value ranging from 3 to 14. For the PDSCH mapping type B, S takes a value ranging from 0 to 12. L takes one of the values {2, 4, and 7}. However, the sum of S and L takes a value ranging from 2 to 14.

The position of a DMRS symbol for the PDSCH depends on the type of the PDSCH mapping. The position of the first DMRS symbol (first DM-RS symbol) for the PDSCH depends on the type of the PDSCH mapping. For the PDSCH mapping type A, the position of the first DMRS symbol may be indicated in a higher layer parameter dmrs-TypeA-Position. In other words, the higher layer parameter dmrs-TypeA-Position is used to indicate the position of the first DMRS for the PDSCH or PUSCH. dmrs-TypeA-Position may be set to either ‘pos2’ or ‘pos3’. For example, in a case that dmrs-TypeA-Position is set to ‘pos2’, the position of the first DMRS symbol for the PDSCH may correspond to the third symbol in the slot. For example, in a case that dmrs-TypeA-Position is set to ‘pos3’, the position of the first DMRS symbol for the PDSCH may correspond to the fourth symbol in the slot. In this regard, S can take a value of 3 only in a case that dmrs-TypeA-Position is set to ‘pos3’. In other words, in a case that dmrs-TypeA-Position is set to ‘pos2’, then S takes a value ranging from 0 to 2. For the PDSCH mapping type B, the position of the first DMRS symbol corresponds to the first symbol of the allocated PDSCH.

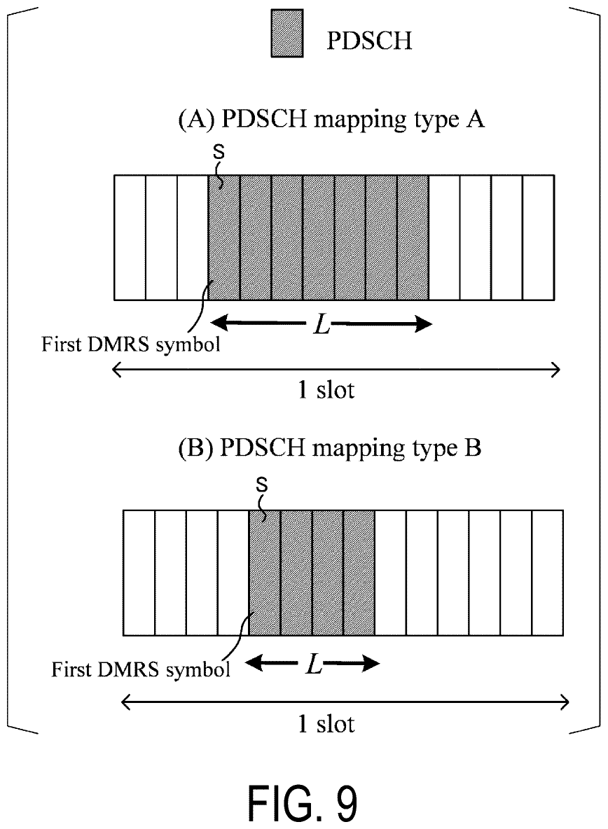

FIG. 9 is a diagram illustrating an example of the PDSCH mapping types according to the present embodiment. FIG. 9(A) is a diagram illustrating an example of the PDSCH mapping type A. In FIG. 9(A), S of the allocated PDSCH is 3. L of the allocated PDSCH is 7. In FIG. 9(A), the position of the first DMRS symbol for the PDSCH corresponds to the fourth symbol in the slot. In other words, dmrs-TypeA-Position is set to ‘pos3’. FIG. 9(B) is a diagram illustrating an example of the PDSCH mapping type A. In FIG. 9(B), S of the allocated PDSCH is 4. L of the allocated PDSCH is 4. In FIG. 9(B), the position of the first DMRS symbol for the PDSCH corresponds to the first symbol to which the PDSCH is allocated.

The Random Access procedure according to the present embodiment will be described.

The random access procedure is classified into two procedures, namely a Contention Based (CB) procedure and a non-contention based (non-CB) (which may be referred to as Contention Free (CF)) procedure. The contention based random access is also referred to as CBRA, and the non-contention based random access is also referred to as CFRA.

The random access procedure is initiated by a PDCCH order, a MAC entity, a notification of a beam failure from a lower layer, RRC, or the like.

The contention based random access procedure is initiated by a PDCCH order, a MAC entity, a notification of a beam failure from a lower layer, RRC, or the like. In a case that a beam failure notification is provided to the MAC entity of the terminal apparatus 1 from the physical layer of the terminal apparatus 1 and a certain condition is satisfied, the MAC entity of the terminal apparatus 1 initiates the random access procedure. In a case that the beam failure notification is provided to the MAC entity of the terminal apparatus 1 from the physical layer of the terminal apparatus 1, a procedure of judging whether a certain condition is satisfied and initiating the random access procedure may be referred to as a beam failure recovery procedure. The random access procedure is a random access procedure for a beam failure recovery request. The random access procedure initiated by the MAC entity includes the random access procedure initiated by a scheduling request procedure. The random access procedure for the beam failure recovery request may or may not be considered as the random access procedure initiated by the MAC entity. Different procedures may be performed between the random access procedure for the beam failure recovery request and the random access procedure initiated by the scheduling request procedure, and thus the random access procedure for the beam failure recovery request and the scheduling request procedure may be distinguished. The random access procedure for the beam failure recovery request and the scheduling request procedure may be the random access procedure initiated by the MAC entity. In one embodiment, the random access procedure initiated by the scheduling request procedure may be referred to as a random access procedure initiated by the MAC entity, and the random access procedure for the beam failure recovery request may be referred to as a random access procedure due to a notification of a beam failure from a lower layer. In the following, initiation of the random access procedure in a case of receiving a notification of a beam failure from a lower layer may mean initiation of the random access procedure for the beam failure recovery request.

The terminal apparatus 1 performs the contention based random access procedure in a case of initial access from a state in which connection (communication) is not established with the base station apparatus 3, a case of a scheduling request in a case that transmittable uplink data or transmittable sidelink data is generated in the terminal apparatus 1 although connection is established with the base station apparatus 3, and/or the like. Note that application of the contention based random access is not limited to these.

The non-contention based random access procedure may be initiated in a case that the terminal apparatus 1 receives information for indicating initiation of the random access procedure from the base station apparatus 3. The non-contention based random access procedure may be initiated in a case that the MAC layer of the terminal apparatus 1 receives a notification of a beam failure from a lower layer.

The non-contention based random access may be used for rapidly establishing uplink synchronization between the terminal apparatus 1 and the base station apparatus 3 in a case that a handover and transmission timing of a mobile station apparatus are not effective although the base station apparatus 3 and the terminal apparatus 1 are in connection. The non-contention based random access may be used for transmitting the beam failure recovery request in a case that a beam failure is generated in the terminal apparatus 1. Note that application of the non-contention based random access is not limited to these.

Note that information for indicating initiation of the random access procedure may be referred to as a message 0, Msg.0, an NR-PDCCH order, a PDCCH order, or the like.

The terminal apparatus 1 according to the present embodiment receives random access configuration information via a higher layer before initiating the random access procedure.

For the terminal apparatus 1, the base station apparatus 3 transmits an RRC parameter including the random access configuration information to the terminal apparatus 1 as an RRC message.

The terminal apparatus 1 may select one or multiple available random access preambles and/or one or multiple available physical random access channels (a Physical Random Access Channel (PRACH)) occasion (which may be referred to as a Random Access Channel (RACH) occasion, a PRACH transmission occasion, or a RACH transmission occasion) to be used for the random access procedure, based on channel characteristics with the base station apparatus 3. The terminal apparatus 1 may select one or multiple available random access preambles and/or one or multiple PRACH occasions to be used for the random access procedure, based on channel characteristics (which may be, for example, reference signal received power (RSRP)) measured using a reference signal (for example, an SS/PBCH block and/or a CSI-RS) received from the base station apparatus 3.

The random access procedure is implemented through transmission and/or reception of multiple types of messages between the terminal apparatus 1 and the base station apparatus 3. For example, in 4-step random access, the following four messages are transmitted and/or received.

### Message 1

The terminal apparatus 1 in which transmittable uplink data or transmittable sidelink data is generated transmits a preamble for random access (referred to as a random access preamble) to the base station apparatus 3 on the PRACH. The transmitted random access preamble may be referred to as a message 1 or a Msg1. The random access preamble is configured to notify the base station apparatus 3 of information through multiple sequences. For example, in a case that 64 types of sequences are prepared, 6-bit information can be indicated to the base station apparatus 3. The information is indicated as a Random Access preamble Identifier. A preamble sequence is selected out of a preamble sequence set using preamble indexes. The random access preamble selected in indicated PRACH resources is transmitted.

### Message 2

The base station apparatus 3 that has received the random access preamble generates a Random Access Response (RAR) including an uplink grant for indicating transmission to the terminal apparatus 1, and transmits the generated random access response to the terminal apparatus 1 on the PDSCH. The random access response may be referred to as a message 2 or a Msg2. The base station apparatus 3 calculates a difference of transmission timings between the terminal apparatus 1 and the base station apparatus 3 from the received random access preamble, and includes transmission timing adjustment information (Timing Advance Command) for adjusting the difference in the message 2. The base station apparatus 3 includes the random access preamble identifier corresponding to the received random access preamble in the message 2. The base station apparatus 3 transmits, on the PDCCH, DCI with a CRC scrambled with random access response identification information (Random Access-Radio Network Temporary Identity (RA-RNTI)) for indicating a random access response addressed to the terminal apparatus 1 that has transmitted the random access preamble. The RA-RNTI is determined depending on frequency and time location information of the PRACH on which the random access preamble is transmitted.

### Message 3

The terminal apparatus 1 that has transmitted the random access preamble performs monitoring of the PDCCH for the random access response identified with the RA-RNTI within multiple subframe periods (referred to as RAR windows) after transmission of the random access preamble. The terminal apparatus 1 that has transmitted the random access preamble performs decoding of the random access response mapped to the PDSCH, in a case of detecting the corresponding RA-RNTI. The terminal apparatus 1 that has succeeded in decoding of the random access response checks whether or not the random access preamble identifier corresponding to the transmitted random access preamble is included in the random access response. In a case that the random access preamble identifier is included, an out-of-sync state is corrected using the transmission timing adjustment information indicated by the random access response. The terminal apparatus 1 transmits data stored in a buffer to the base station apparatus 3, using an uplink grant included in the received random access response. The data transmitted using the uplink grant in this case is referred to as a message 3 or a Msg3.

In a case that the successfully decoded random access response is the random access response that is successfully received first in a series of random access procedures, the terminal apparatus 1 includes information (C-RNTI) for identifying the terminal apparatus 1 in the message 3 to be transmitted to transmit the information to the base station apparatus 3.

### Message 4

In a case that the base station apparatus 3 receives an uplink transmission in resources allocated to the message 3 of the terminal apparatus 1 in the random access response, the base station apparatus 3 detects a C-RNTI MAC CE included in the received message 3. Then, in a case of establishing connection with the terminal apparatus 1, the base station apparatus 3 transmits the PDCCH to the detected C-RNTI. In a case of transmitting the PDCCH to the detected C-RNTI, the base station apparatus 3 includes an uplink grant in the PDCCH. These PDCCHs transmitted by the base station apparatus 3 are referred to as a message 4, a Msg4, or a contention resolution message.

The terminal apparatus 1 that has transmitted the message 3 starts a contention resolution timer that defines a period of monitoring the message 4 from the base station apparatus 3, and attempts to receive the PDCCH transmitted from the base station within the timer. In a case that the terminal apparatus 1 that has transmitted the C-RNTI MAC CE in the message 3 receives the transmitted PDCCH addressed to the C-RNTI from the base station apparatus 3 and an uplink grant for a new transmission is included in the PDCCH, the terminal apparatus 1 considers that contention resolution with another terminal apparatus 1 has succeeded, stops the contention resolution timer, and ends the random access procedure. In a case that reception of the PDCCH addressed to the C-RNTI that the apparatus has transmitted in the message 3 cannot be checked within a timer period, the apparatus considers that contention resolution did not succeed, and the terminal apparatus 1 performs transmission of the random access preamble again, and continues the random access procedure. Note that, in a case that transmission of the random access preamble is repeated a prescribed number of times and contention resolution does not succeed, it is determined that the random access has a problem and a higher layer is notified of the random access problem. For example, the higher layer may reset the MAC entity, based on the random access problem. In a case that reset of the MAC entity is requested by the higher layer, the terminal apparatus 1 stops the random access procedure.

Through transmission and/or reception of the four messages described above, the terminal apparatus 1 can establish synchronization with the base station apparatus 3, and can thereby perform uplink data transmission to the base station apparatus 3. Note that 2-step random access may be used in which the terminal apparatus 1 and the base station apparatus 3 establish synchronization through transmission and/or reception of two messages of a message A and a message B, which are shortened from the four messages.

A method for specifying the PDSCH time domain resource allocation will be described below.

The base station apparatus 3 may use the DCI to perform scheduling such that the terminal apparatus 1 receives the PDSCH. The terminal apparatus 1 may receive the PDSCH by detecting the DCI addressed to the terminal apparatus 1. In identifying the PDSCH time domain resource allocation, the terminal apparatus 1 determines a resource allocation table to be applied to the PDSCH. The resource allocation table includes one or multiple PDSCH time domain resource allocation configurations. The terminal apparatus 1 may select one PDSCH time domain resource allocation configuration in the determined resource allocation table, based on a value indicated in a ‘Time domain resource assignment’ (TDRA) field included in the DCI scheduling the PDSCH. In other words, the base station apparatus 3 determines the PDSCH resource allocation for the terminal apparatus 1, generates a TDRA field with a value based on the determined resource allocation, and transmits the DCI including the TDRA field to the terminal apparatus 1. The terminal apparatus 1 specifies resources of the PDSCH in the time domain, using the value of the TDRA field included in the received DCI and the PDSCH time domain resource allocation configuration indicating mapping between the value of the TDRA field and the time domain resources.

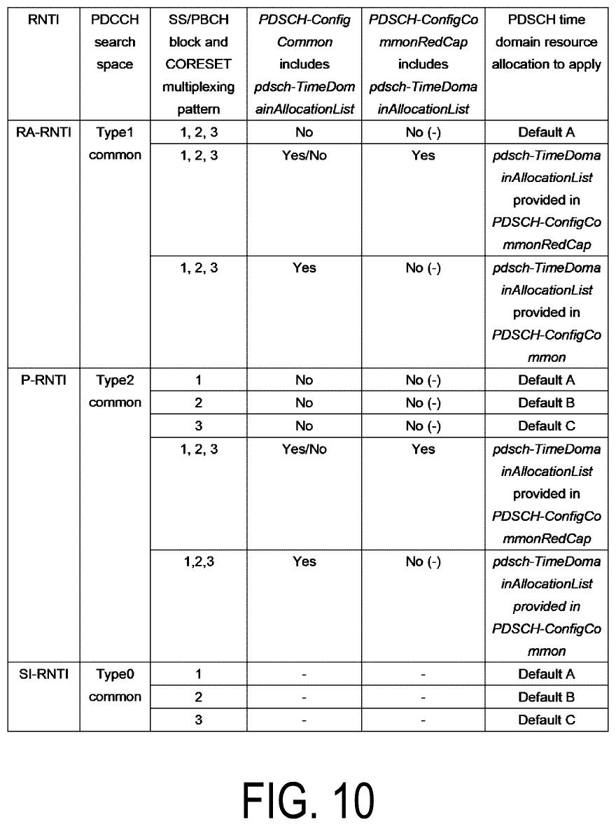

FIG. 10 is a diagram illustrating an example of a criterion for selecting the resource allocation table to be applied to the PDSCH time domain resource allocation according to an embodiment of the present invention. The terminal apparatus 1 may determine the resource allocation table to be applied to the PDSCH time domain resource allocation, based on the table illustrated in FIG. 10. The base station apparatus 3 may determine the resource allocation table to be applied to the PDSCH time domain resource allocation, based on the table illustrated in FIG. 10. The resource allocation table includes one or multiple PDSCH time domain resource allocation configurations. In the present embodiment, each resource allocation table is classified as one of (I) a predefined resource allocation table and (II) a resource allocation table configured from higher layer RRC signaling. The predefined resource allocation table is referred to as a default table, and is defined, for example, as a default PDSCH time domain resource allocation A, a default PDSCH time domain resource allocation B, and a default PDSCH time domain resource allocation C. A default PDSCH time domain resource allocation D different from the default PDSCH time domain resource allocation A may be defined. Hereinafter, the default PDSCH time domain resource allocation A is referred to as a default table A, the default PDSCH time domain resource allocation B is referred to as a default table B, the default PDSCH time domain resource allocation C is referred to as a default table C, and the default PDSCH time domain resource allocation D is referred to as a default table D. Note that different default tables may be defined as the default tables for cases that the Cyclic prefix (CP) added to the PDSCH is a normal CP (NCP) and is an extended CP (ECP). In a case that there is not an indication in particular, the default table may be a table of a case that the Cyclic prefix (CP) added to the DSCH is a normal CP (NCP).

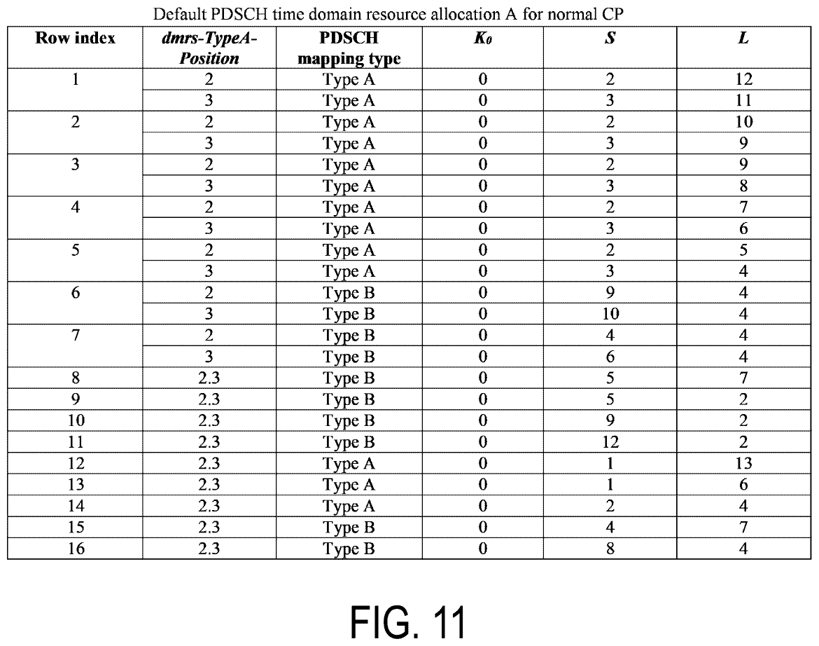

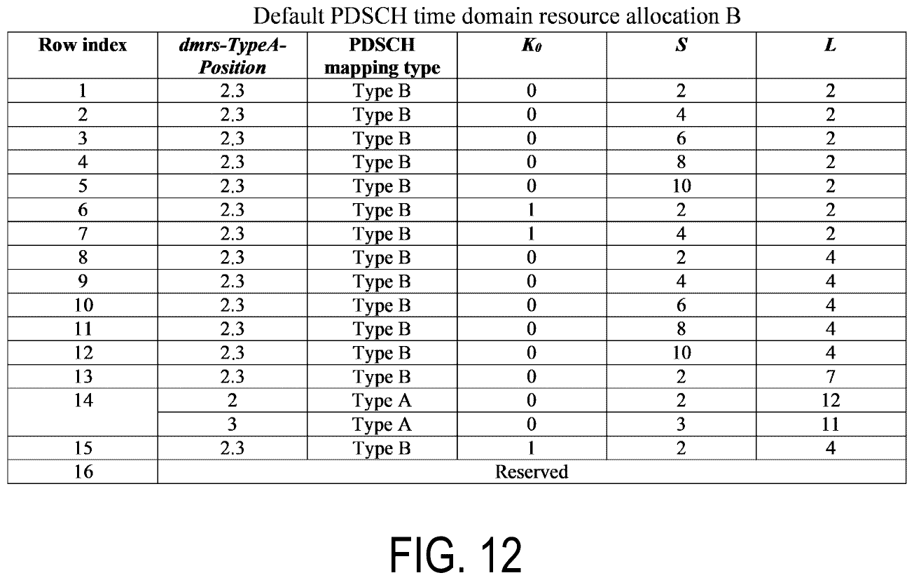

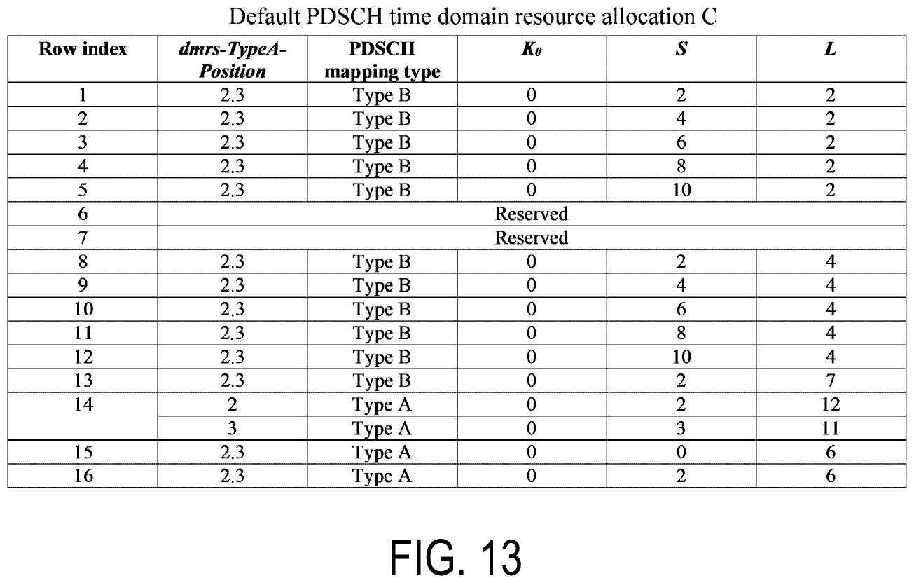

FIG. 11 is a diagram illustrating an example of the default table A according to the present embodiment. FIG. 12 is a diagram illustrating an example of the default table B according to the present embodiment. FIG. 13 is a diagram illustrating an example of the default table C according to the present embodiment. In the example in FIG. 11, the number of rows in the default table A is 16, and each row indicates the PDSCH time domain resource allocation configuration. In FIG. 11, each of the rows defines the PDSCH mapping type, a slot offset K₀ between the PDCCH including the DCI and the PDSCH scheduled by the PDCCH, the starting symbol S for the PDSCH within the slot, and the number L of continuous allocated symbols.

The resource allocation table configured by higher layer RRC signaling is given by higher layer signaling pdsch-TimeDomainAllocationList. pdsch-TimeDomainAllocationList includes one or multiple information elements PDSCH-TimeDomainResourceAllocation. PDSCH-TimeDomainResourceAllocation indicates the PDSCH time domain resource allocation configuration. PDSCH-TimeDomainResourceAllocation may be used to configure a time domain relationship between the PDCCH including the DCI and the PDSCH scheduled by the PDCCH. pdsch-TimeDomainAllocationList is a list including one or multiple information elements. One PDSCH-TimeDomainResourceAllocation may also be referred to as one entry (or one row). For example, pdsch-TimeDomainAllocationList includes up to 16 entries, and any one entry may be used by the TDRA field of 4 bits included in the DCI. However, the number of entries included in pdsch-TimeDomainAllocationList may be a different number, and the number of bits in the TDRA field included in the DCI in connection with pdsch-TimeDomainAllocationList may have a different value. The entries in pdsch-TimeDomainAllocationList may indicate K₀, mappingType, and/or startSymbolAndLength. K₀ indicates a slot offset between the PDCCH including the DCI and the PDSCH scheduled by the PDCCH. In a case that PDSCH-TimeDomainResourceAllocation does not indicate K₀, the terminal apparatus 1 may assume that K₀ has a prescribed value (for example, 0). mappingType indicates whether the mapping type of the corresponding PDSCH is the PDSCH mapping type A or the PDSCH mapping type B. startSymbolAndLength is an index providing an effective combination of the starting symbol S of the corresponding PDSCH and the number L of continuous allocated symbols. startSymbolAndLength may be referred to as a start and length indicator (SLIV). In a case that the SLIV is applied, then unlike in a case that the default table is used, the corresponding starting symbol S of the corresponding PDSCH and the corresponding number L of continuous symbols may be given based on the SLIV. The base station apparatus 3 may set the SLIV value such that the PDSCH time domain resource allocation does not exceed the slot boundary.

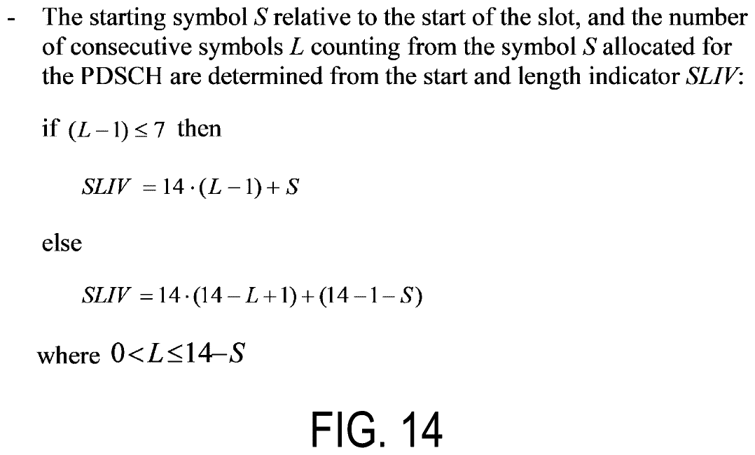

FIG. 14 is a diagram illustrating an example of calculation of the SLIV.

In FIG. 14, 14 is the number of symbols included in one slot. FIG. 14 illustrates an example of calculation of the SLIV for the Normal Cyclic Prefix (NCP). The value of the SLIV is calculated based on the number of symbols included in the slot, the starting symbol S, and the number L of continuous symbols. Here, the value of L is equal to or greater than 1 and does not exceed (14-S). In a case of calculation of the SLIV for the ECP, instead of values 7 and 14 in FIGS. 14, 6 and 12 are used.

The slot offset K₀ will be described below.

As described above, at the subcarrier spacing configuration μ, the slots are counted in ascending order from 0 to N\hat{ }{subframe, μ} _{slot}−1 within the subframe, and counted in ascending order from 0 to N\hat{ }{frame, μ} _{slot}−1 within the frame. K₀ is the number of slots based on the subcarrier spacing of the PDSCH. K₀ may take a value ranging from 0 to 32. In a certain subframe or frame, the number of the slots is counted in ascending order from 0. Slot number n with a subcarrier spacing configuration of 15 kHz corresponds to slot numbers 2n and 2n+1 with a subcarrier spacing configuration of 30 kHz.

In a case that the terminal apparatus 1 detects DCI scheduling the PDSCH, the slot assigned to the PDSCH is given by floor (n*2^{μPDSCH}/2^{μPDCCH})+K₀. The function floor (A) outputs a maximum integer that does not exceed A. n is a slot in which a PDCCH that schedules the PDSCH is detected. μ_{PDSCH} is a subcarrier spacing configuration for the PDSCH. μ_{PDCCH} is a subcarrier spacing configuration for the PDCCH.

The higher layer signaling pdsch-TimeDomainAllocationList may be included in a cell-specific RRC parameter pdsch-ConfigCommon in downlinkConfigCommon, a cell-specific RRC parameter pdsch-ConfigCommon in downlinkConfigCommonRedCap, and/or a terminal apparatus 1 (UE)-specific RRC parameter pdsch-Config. pdsch-ConfigCommon in downlinkConfigCommon or in downlinkConfigCommonRedCap is used to configure the cell-specific parameter for the PDSCH for a downlink BWP. pdsch-Config is used to configure the terminal apparatus 1 (UE)-specific parameter for the PDSCH for a downlink BWP.

The terminal apparatus 1 may apply different resource allocation tables to the PDSCH time domain resource allocation, based on a type (value) of an RNTI for scrambling a CRC to be added to the DCI for scheduling the PDSCH, a type of a search space of the PDCCH for receiving the DCI for scheduling the PDSCH, a multiplexing pattern of an SS/PBCH block and a CORESET, configuration information included in a SIB1, configuration information included in another SIB, and/or configuration information included in an RRC parameter. The base station apparatus 3 may apply different resource allocation tables to the PDSCH time domain resource allocation, based on a type (value) of an RNTI for scrambling a CRC to be added to the DCI for scheduling the PDSCH, a type of a search space of the PDCCH for receiving the DCI for scheduling the PDSCH, a multiplexing pattern of an SS/PBCH block and a CORESET, configuration information included in a SIB1, configuration information included in another SIB, and/or configuration information included in an RRC parameter.

In a case that the resource allocation table to be applied to the PDSCH time domain resource allocation is given by pdsch-TimeDomainAllocationList, different resource allocation tables may be configured for cases that the pdsch-TimeDomainAllocationList is included in the cell-specific RRC parameter pdsch-ConfigCommon in downlinkConfigCommon, is included in the cell-specific RRC parameter pdsch-ConfigCommon in downlinkConfigCommonRedCap, and is included in the terminal apparatus 1 (UE)-specific RRC parameter pdsch-Config. The terminal apparatus 1 may determine pdsch-TimeDomainAllocationList to be applied to the resource allocation table to be applied to the PDSCH time domain resource allocation, based on whether pdsch-TimeDomainAllocationList is included in pdsch-ConfigCommon, pdsch-ConfigCommonRedCap, and/or pdsch-Config.

In the following, for the sake of description, in an aspect of the present invention, pdsch-TimeDomainAllocationList that may be included in pdsch-ConfigCommon is referred to as pdsch-TimeDomainAllocationList1, pdsch-TimeDomainAllocationList that may be included in pdsch-ConfigCommonRedCap is referred to as pdsch-TimeDomainAllocationList2, and pdsch-TimeDomainAllocationList that may be included in pdsch-Config is referred to as pdsch-TimeDomainAllocationList3.

The terminal apparatus 1 may determine whether to use pdsch-TimeDomain AllocationList1, use pdsch-TimeDomainAllocationList2, use pdsch-TimeDomainAllocationList3, and/or use the default table (for example, the default table A) for the resource allocation table to be applied to the PDSCH time domain resource allocation, based on whether pdsch-TimeDomainAllocationList1 (first parameter list) is included in pdsch-ConfigCommon, pdsch-TimeDomainAllocationList2 (second parameter list) is included in pdsch-ConfigCommonRedCap, and/or pdsch-TimeDomainAllocationList3 (third parameter list) is included in pdsch-Config. For example, the terminal apparatus 1 may determine whether to use pdsch-TimeDomainAllocationList1, use pdsch-TimeDomainAllocationList2, and/or use the default table (for example, the default table A) for the resource allocation table to be applied to the PDSCH time domain resource allocation, based on whether pdsch-TimeDomainAllocationList1 is included in pdsch-ConfigCommon and/or pdsch-TimeDomainAllocationList2 is included in pdsch-ConfigCommonRedCap. The base station apparatus 3 may transmit pdsch-TimeDomainAllocationList, using pdsch-ConfigCommon, pdsch-ConfigCommonRedCap, and/or pdsch-Config, in order to cause the terminal apparatus 1 to determine the parameter list to be used for the resource allocation table.

In the present embodiment, pdsch-TimeDomainAllocationList (pdsch-TimeDomainAllocationList2) that may be included in pdsch-ConfigCommonRedCap has the same information element configuration as pdsch-TimeDomainAllocationList (pdsch-TimeDomainAllocationList2) that may be included in pdsch-ConfigCommon, but may have a different information element configuration. Similarly to pdsch-TimeDomainAllocationList1, pdsch-TimeDomainAllocationList2 may include up to 16 entries, and any one of the entries may be used by the field (TDRA field) of 4 bits included in the DCI. The entries included in pdsch-TimeDomainAllocationList2 may indicate K₀, mappingType, startSymbolAndLength, and/or other parameters. The values available for K₀, mappingType, and/or startSymbolAndLength in the entries in pdsch-TimeDomainAllocationList2 may differ from the values available in pdsch-TimeDomainAllocationList1. For example, the value of K₀ available in pdsch-TimeDomainAllocationList1 may range from 0 to 32, and the value of K₀ available in pdsch-TimeDomainAllocationList2 may range from 0 to 4. For example, mappingType available in pdsch-TimeDomainAllocationList1 may include mapping type A and mapping type B, and mappingType available in pdsch-TimeDomainAllocationList2 may include only mapping type B. For example, pdsch-TimeDomainAllocationList2 need not indicate mappingType.

The terminal apparatus 1 may determine/specify/configure/set the parameter list or the default table (for example, pdsch-TimeDomainAllocationList1, pdsch-TimeDomainAllocationList2, and/or the default table A) to be applied to the PDSCH time domain resource allocation configuration, based on whether one or multiple prescribed conditions apply. For example, the terminal apparatus 1 may at least judge whether pdsch-TimeDomainAllocationList1 is provided in the SIB (which may be the SIB1), pdsch-TimeDomainAllocationList2 is provided in the SIB (which may be the SIB1), and/or a prescribed common search space (CSS) and/or the CORESET associated with the CSS is configured for a corresponding separate initial downlink BWP, and determine, as a result of the determination, whether to apply pdsch-TimeDomainAllocationList1, apply pdsch-TimeDomainAllocationList2, or apply the default table A to the PDSCH time domain resource allocation configuration.

Note that “pdsch-TimeDomainAllocationList1 is provided in the SIB” may mean that pdsch-TimeDomainAllocationList1 is included in a parameter provided in the SIB. “pdsch-TimeDomainAllocationList1 is not provided in the SIB” may mean that pdsch-TimeDomainAllocationList1 is not included in a parameter (for example, PDSCH-ConfigCommon) provided in the SIB, and/or a parameter (for example, PDSCH-ConfigCommon) including pdsch-TimeDomainAllocationList1 is not provided in the SIB.

Note that “pdsch-TimeDomainAllocationList2 is provided in the SIB” may mean that pdsch-TimeDomainAllocationList2 is included in a parameter provided in the SIB. “pdsch-TimeDomainAllocationList2 is not provided in the SIB” may mean that pdsch-TimeDomainAllocationList2 is not included in a parameter (for example, PDSCH-ConfigCommonRedCap) provided in the SIB, and/or a parameter (for example, PDSCH-ConfigCommonRedCap) including pdsch-TimeDomainAllocationList2 is not provided in the SIB.

The parameter list and/or the default table (for example, pdsch-TimeDomainAllocationList1, pdsch-TimeDomainAllocationList2, and/or the default table A) to be applied to the PDSCH time domain resource allocation configuration may be determined/specified/configured/set, based on whether PDSCH-ConfigCommon includes pdsch-TimeDomainAllocationList1, PDSCH-ConfigCommonRedCap being a configuration corresponding to the separate initial downlink BWP includes pdsch-TimeDomainAllocationList2, and a prescribed common search space (CSS) and/or the CORESET associated with the CSS is configured for a corresponding separate initial downlink BWP.

In order to receive the random access response via the PDSCH in the separate initial downlink BWP, the terminal apparatus 1 needs to be configured with the common search space in the separate initial downlink BWP. Thus, it is considered that an appropriate parameter list for the PDSCH time domain resource allocation configuration to be used for reception of a corresponding PDSCH is different, based on whether or not a prescribed common search space (CSS) and/or the CORESET associated with the CSS is configured for the separate initial downlink BWP. Thus, whether a prescribed common search space (CSS) and/or the CORESET associated with the CSS is configured for the separate initial downlink BWP may be judged, and as a result of the judgment, whether to apply pdsch-TimeDomainAllocationList1, apply pdsch-TimeDomainAllocationList2, or apply the default table A to the PDSCH time domain resource allocation configuration may be determined. For example, in a case that a prescribed common search space (CSS) and/or the CORESET associated with the CSS is configured for the separate initial downlink BWP, the terminal apparatus 1 may apply pdsch-TimeDomainAllocationList2 or the default table A to the PDSCH time domain resource allocation configuration, and in a case that a prescribed common search space (CSS) and/or the CORESET associated with the CSS is not configured for the separate initial downlink BWP, the terminal apparatus 1 may apply pdsch-TimeDomainAllocationList1 or the default table A to the PDSCH time domain resource allocation configuration.

Note that “a prescribed common search space (CSS) is configured for the separate initial downlink BWP” may mean that the CSS for monitoring a corresponding PDCCH is configured using pdcch-ConfigCommonRedCap included in separateInitialDownlinkBWP being the configuration of the separate initial downlink BWP. For example, it may mean that the search space ID of the CSS is indicated by the parameter ra-SearchSpace included in pdcch-ConfigCommonRedCap for the terminal apparatus 1 that receives the DCI with the CRC scrambled with the RA-RNTI in the CSS.

Note that “the CORESET associated with the CSS is configured for the separate initial downlink BWP” may mean that the CSS that refers to the CORESET configured with the pdcch-ConfigCommonRedCap is configured in pdcch-ConfigCommonRedCap included in separateInitialDownlinkBWP being the configuration of the separate initial downlink BWP. For example, it may mean that the search space ID of the CSS is indicated by the parameter ra-SearchSpace included in pdcch-ConfigCommonRedCap for the terminal apparatus 1 that receives the DCI with the CRC scrambled with the RA-RNTI in the CSS, and the CSS specified with the search space ID is associated with the CORESET specified with controlResourceSetId indicated by the parameter SearchSpace in the parameter commonSearchSpaceList included in pdcch-ConfigCommonRedCap.

Note that “the CORESET associated with the CSS is configured for the separate initial downlink BWP” may mean that the CSS that refers to the CORESET located within a band of the separate initial downlink BWP is configured in the frequency domain in pdcch-ConfigCommonRedCap included in separateInitialDownlinkBWP being the configuration of the separate initial downlink BWP. For example, it may mean that the search space ID of the CSS is indicated by the parameter ra-SearchSpace included in pdcch-ConfigCommonRedCap for the terminal apparatus 1 that receives the DCI with the CRC scrambled with the RA-RNTI in the CSS, the CSS specified with the search space ID is associated with the CORESET specified with controlResourceSetId indicated by the parameter SearchSpace in the parameter commonSearchSpaceList included in pdcch-ConfigCommonRedCap, and the frequency location of the specified CORESET is within a band of the separate initial downlink BWP.

Note that “the CORESET associated with the CSS is configured for the separate initial downlink BWP” may mean that the CSS that refers to the CORESET located out of a band of the separate initial downlink BWP is configured in the frequency domain in pdcch-ConfigCommonRedCap included in separateInitialDownlinkBWP being the configuration of the separate initial downlink BWP. For example, it may mean that the search space ID of the CSS is indicated by the parameter ra-SearchSpace included in pdcch-ConfigCommonRedCap for the terminal apparatus 1 that receives the DCI with the CRC scrambled with the RA-RNTI in the CSS, the CSS specified with the search space ID is associated with the CORESET specified with controlResourceSetId indicated by the parameter SearchSpace in the parameter commonSearchSpaceList included in pdcch-ConfigCommonRedCap, and the frequency location of the specified CORESET is out of a band of the separate initial downlink BWP.

Note that “the CORESET associated with the CSS is configured for the separate initial downlink BWP” may mean that, in pdcch-ConfigCommonRedCap included in separateInitialDownlinkBWP being the configuration of the separate initial downlink BWP, the CSS that refers to the CORESET configured with the pdcch-ConfigCommonRedCap is configured, and the frequency location of the CORESET is out of a band of a corresponding separate initial downlink BWP. For example, a prescribed CORESET may be a CORESET specified with the parameter controlResourceSetId in the parameter SearchSpace for configuring a corresponding CSS in pdcch-ConfigCommonRedCap.

As an example of a condition that the terminal apparatus 1 applies pdsch-TimeDomainAllocationList2 to the PDSCH time domain resource allocation configuration, the following condition (A1) or (A2) may be used.

(A1) A case that pdsch-TimeDomainAllocationList2 is provided in the SIB (for example, a case that the parameter (for example, PDSCH-ConfigCommonRedCap) provided in the SIB includes pdsch-TimeDomainAllocationList2) (regardless of whether or not pdsch-TimeDomainAllocationList1 is provided in the SIB)

(A2) A case that pdsch-TimeDomainAllocationList2 is provided in the SIB (for example, a case that the parameter (for example, PDSCH-ConfigCommonRedCap) provided in the SIB includes pdsch-TimeDomainAllocationList2) (regardless of whether or not pdsch-TimeDomainAllocationList1 is provided in the SIB), and the CORESET associated with the CSS for monitoring a corresponding PDCCH is configured for the initial downlink BWP (separate initial downlink BWP) configured with separateInitialDownlinkBWP including the pdsch-TimeDomainAllocationList2

As an example of condition(s) that the terminal apparatus 1 applies pdsch-TimeDomainAllocationList1 to the PDSCH time domain resource allocation configuration, one or more of the following conditions (B1) to (B5) may be used.

(B1) A case that pdsch-TimeDomainAllocationList2 is not provided in the SIB (a case that the parameter (for example, PDSCH-ConfigCommonRedCap) provided in the SIB does not include pdsch-TimeDomainAllocationList2, and/or a case that the SIB does not provide the parameter (PDSCH-ConfigCommonRedCap) including pdsch-TimeDomainAllocationList2), and pdsch-TimeDomainAllocationList1 is provided in the SIB (for example, a case that the parameter (for example, PDSCH-ConfigCommon) provided in the SIB includes pdsch-TimeDomainAllocationList)

(B2) A case that separateInitialDownlinkBWP is not provided in the SIB, and pdsch-TimeDomainAllocationList1 is provided in the SIB (for example, a case that the parameter (for example, PDSCH-ConfigCommon) provided in the SIB includes pdsch-TimeDomainAllocationList)

(B3) A case that pdsch-TimeDomainAllocationList1 is provided in the SIB (for example, a case that the parameter (for example, PDSCH-ConfigCommon) provided in the SIB includes pdsch-TimeDomainAllocationList), pdsch-TimeDomainAllocationList2 is not provided in the SIB, and the frequency location of the initial downlink BWP (separate initial downlink BWP) configured with separateInitialDownlinkBWP includes the frequency location of the CORESET #0 configured in the MIB

(B4) A case that the CORESET associated with the CSS for monitoring a corresponding PDCCH is not configured for the initial downlink BWP (separate initial downlink BWP) configured with separateInitialDownlinkBWP, and pdsch-TimeDomainAllocationList1 is provided in the SIB (for example, a case that the parameter (for example, PDSCH-ConfigCommon) provided in the SIB includes pdsch-TimeDomainAllocationList)

(B5) A case that the CORESET associated with the CSS for monitoring a corresponding PDCCH is configured for the initial downlink BWP (separate initial downlink BWP) configured with separateInitialDownlinkBWP, pdsch-TimeDomainAllocationList2 is not provided in the SIB (a case that the parameter (for example, PDSCH-ConfigCommonRedCap) provided in the SIB does not include pdsch-TimeDomainAllocationList2, and/or a case that the SIB does not provide the parameter (PDSCH-ConfigCommonRedCap) including pdsch-TimeDomainAllocationList2), and pdsch-TimeDomainAllocationList1 is provided in the SIB (for example, a case that the parameter (for example, PDSCH-ConfigCommon) provided in the SIB includes pdsch-TimeDomainAllocationList)

As an example of condition(s) that the terminal apparatus 1 applies the default table (for example, the default table A, the default table B, or the default table C) to the PDSCH time domain resource allocation configuration, one or more of the following conditions (C1) to (C8) may be used.

(C1) A case that pdsch-TimeDomainAllocationList2 is not provided in the SIB (a case that the parameter (for example, PDSCH-ConfigCommonRedCap) provided in the SIB does not include pdsch-TimeDomainAllocationList2, and/or a case that the SIB does not provide the parameter (PDSCH-ConfigCommonRedCap) including pdsch-TimeDomainAllocationList2), and pdsch-TimeDomainAllocationList1 is not provided in the SIB (for example, a case that the parameter (for example, PDSCH-ConfigCommon) provided in the SIB does not include pdsch-TimeDomainAllocationList1, and/or a case that the SIB does not provide the parameter (PDSCH-ConfigCommon) including pdsch-TimeDomainAllocationList1)

(C3) pdsch-TimeDomainAllocationList2 is not provided in the SIB (a case that the parameter (for example, PDSCH-ConfigCommonRedCap) provided in the SIB does not include pdsch-TimeDomainAllocationList2, and/or a case that the SIB does not provide the parameter (PDSCH-ConfigCommonRedCap) including pdsch-TimeDomainAllocationList2)

(C4) A case that the parameter (for example, PDSCH-ConfigCommonRedCap) provided in the SIB does not include pdsch-TimeDomainAllocationList2, or the SIB does not provide the parameter (PDSCH-ConfigCommonRedCap) including pdsch-TimeDomainAllocationList2, and a case that pdsch-TimeDomainAllocationList1 is not provided in the SIB (for example, a case that the parameter (for example, PDSCH-ConfigCommon) provided in the SIB does not include pdsch-TimeDomainAllocationList1, and/or a case that the SIB does not provide the parameter (PDSCH-ConfigCommon) including pdsch-TimeDomainAllocationList1)

(C5) A case that pdsch-TimeDomainAllocationList1 is provided in the SIB (for example, a case that the parameter (for example, PDSCH-ConfigCommon) provided in the SIB includes pdsch-TimeDomainAllocationList), the parameter (for example, PDSCH-ConfigCommonRedCap) provided in the SIB does not include pdsch-TimeDomainAllocationList2, and the frequency location of the initial downlink BWP (separate initial downlink BWP) configured with separateInitialDownlinkBWP does not include the frequency location of the CORESET #0 configured in the MIB, or a case that pdsch-TimeDomainAllocationList2 is not provided in the SIB, and pdsch-TimeDomainAllocationList1 is not provided in the SIB

(C6) A case that the CORESET associated with the CSS for monitoring a corresponding PDCCH is not configured for the initial downlink BWP (separate initial downlink BWP) configured with separateInitialDownlinkBWP, and pdsch-TimeDomainAllocationList1 is not provided in the SIB

(C7) A case that the CORESET associated with the CSS for monitoring a corresponding PDCCH is configured for the initial downlink BWP (separate initial downlink BWP) configured with separateInitialDownlinkBWP, and pdsch-TimeDomainAllocationList1 is not provided in the SIB

(C8) A case that the CORESET associated with the CSS for monitoring a corresponding PDCCH is configured for the initial downlink BWP (separate initial downlink BWP) configured with separateInitialDownlinkBWP, and pdsch-TimeDomainAllocationList1 and pdsch-TimeDomainAllocationList2 are not provided in the SIB

Note that which one of the above-described examples of the condition of applying pdsch-TimeDomainAllocationList1, the condition of applying pdsch-TimeDomainAllocationList1, and the condition of applying the default table to the PDSCH time domain resource allocation configuration is applied may be different based on the type of the RNTI (for example, the SI-RNTI, the RA-RNTI, the MSGB-RNTI, the TC-RNTI, the P-RNTI, the C-RNTI, the MCS-C-RNTI, and/or the CS-RNTI) used for scrambling the CRC to be added to the DCI for scheduling a corresponding PDSCH, the type of the search space (for example, the type 0 common search space, the type 0A common search space, the type 1 common search space, the type 2 common search space, and/or the UE-specific search space) of the PDCCH for transmitting the DCI, whether the search space of the PDCCH for transmitting the DCI is associated with the CORESET #0, whether the search space of the PDCCH for transmitting the DCI is associated with the common CORESET, and/or the multiplexing pattern of the SS/PBCH block and the CORESET. For example, in a case that the RNTI used for scrambling the CRC to be added to the DCI for scheduling a corresponding PDSCH is the RA-RNTI, the terminal apparatus 1 may apply one of the above conditions (A1) to (A2), one of (B1) to (B5), and one of (C1) to (C8), and in a case that the RNTI used for scrambling the CRC to be added to the DCI for scheduling a corresponding PDSCH is the SI-RNTI, the terminal apparatus 1 may apply the default table A, the default table B, or the default table C to the PDSCH time domain resource allocation configuration without applying pdsch-TimeDomainAllocationList1 and pdsch-TimeDomainAllocationList2.

Note that, in each of the conditions described above, “the CSS for monitoring a corresponding PDCCH” and “the CORESET associated with the CSS for monitoring a corresponding PDCCH” are the CSS and the CORESET for monitoring the PDCCH for scheduling the PDSCH to which the PDSCH time domain resource allocation configuration is applied.

As illustrated in FIG. 10, the terminal apparatus 1 may determine the resource allocation table to be applied to the PDSCH time domain resource allocation, based on multiple elements. The terminal apparatus 1 may determine the resource allocation table to be applied to the PDSCH scheduled by the DCI transmitted on the PDCCH, based at least on some or all of element (A) to element (F) described below.
Element (A): the type (value) of the RNTI that scrambles the CRC to be added to the DCI
Element (B): the type of the search space in which the DCI is detected
Element (C): whether the CORESET associated with the search space is CORESET #0
Element (D): whether pdsch-ConfigCommon includes pdsch-TimeDomainAllocationList
Element (E): whether pdsch-ConfigCommonRedCap includes pdsch-TimeDomainAllocationList
Element (F): SS/PBCH block and CORESET multiplexing pattern

For the element (A), the type of the RNTI that scrambles the CRC added to the DCI may be one of the SI-RNTI, the RA-RNTI, the TC-RNTI, the P-RNTI, the C-RNTI, the MCS-C-RNTI, and the CS-RNTI. Although FIG. 10 illustrates cases that the type of the RNTI that scrambles the CRC added to the DCI is the RA-RNTI and the P-RNTI, similar definition may also apply to cases for other types of RNTIs.

For the element (B), the type of the search space in which the DCI is detected is the common search space or the UE-specific search space. The common search space may include a type 0 common search space, a type 0A common search space, a type 1 common search space, and a type 2 common search space. Although FIG. 10 illustrates cases of the type 1 common search space and the type 2 common search space, similar definition may also apply to cases for other search spaces. Note that the element (B) may be associated with the element (A). In a case that the element (A) is a type of a prescribed RNTI, the element (B) may be a type of a search space corresponding to the type of the RNTI.

As example A in FIG. 10, in a case that the terminal apparatus 1 detects DCI in the type 1 common search space and a CRC scrambled with the RA-RNTI is added to the detected DCI, the terminal apparatus 1 may determine the resource allocation table to be applied to the PDSCH scheduled by the DCI. In a case that pdsch-ConfigCommon received on the SIB1/another SIB and/or an RRC message received by the terminal apparatus 1 does not include pdsch-TimeDomainAllocationList (pdsch-TimeDomainAllocationList1) (No), and pdsch-ConfigCommonRedCap received on the SIB1/another SIB and/or an RRC message received by the terminal apparatus 1 does not include pdsch-TimeDomainAllocationList (pdsch-TimeDomainAllocationList2) (No) (or pdsch-ConfigCommonRedCap itself is not configured (−)), the terminal apparatus 1 may determine that the resource allocation table to be applied to the PDSCH time domain resource allocation is the default table A (Default A). In other words, the terminal apparatus 1 may use the default table A indicating the PDSCH time domain resource allocation configuration and apply it to determination of the PDSCH time domain resource allocation. Regardless of whether pdsch-ConfigCommon received on the SIB1/another SIB and/or an RRC message received by the terminal apparatus 1 includes or does not include pdsch-TimeDomainAllocationList (pdsch-TimeDomainAllocationList1) (Yes/No), in a case that pdsch-ConfigCommonRedCap received on the SIB1/another SIB and/or an RRC message received by the terminal apparatus 1 includes pdsch-TimeDomainAllocationList (pdsch-TimeDomainAllocationList2) (Yes), the terminal apparatus 1 may determine that the resource allocation table to be applied to the PDSCH time domain resource allocation is the pdsch-TimeDomainAllocationList2. In other words, the terminal apparatus 1 may apply pdsch-TimeDomainAllocationList included in pdsch-ConfigCommonRedCap to determination of the PDSCH time domain resource allocation. In a case that pdsch-ConfigCommon received on the SIB1/another SIB and/or an RRC message received by the terminal apparatus 1 includes pdsch-TimeDomainAllocationList (pdsch-TimeDomainAllocationList1) (Yes), and pdsch-ConfigCommonRedCap received on the SIB1/another SIB and/or an RRC message received by the terminal apparatus 1 does not include pdsch-TimeDomainAllocationList (pdsch-TimeDomainAllocationList2) (No) (or pdsch-ConfigCommonRedCap itself is not configured (−)), the terminal apparatus 1 may determine that the resource allocation table to be applied to the PDSCH time domain resource allocation is the pdsch-TimeDomainAllocationList1. In other words, the terminal apparatus 1 may apply pdsch-TimeDomainAllocationList included in pdsch-ConfigCommon to determination of the PDSCH time domain resource allocation.

As example B in FIG. 10, in a case that the terminal apparatus 1 detects DCI in the type 2 common search space and a CRC scrambled with the P-RNTI is added to the detected DCI, the terminal apparatus 1 may determine the resource allocation table to be applied to the PDSCH scheduled by the DCI. In a case that pdsch-ConfigCommon received on the SIB1/another SIB and/or an RRC message received by the terminal apparatus 1 does not include pdsch-TimeDomainAllocationList (pdsch-TimeDomainAllocationList1) (No), and pdsch-ConfigCommonRedCap received on the SIB1/another SIB and/or an RRC message received by the terminal apparatus 1 does not include pdsch-TimeDomainAllocationList (pdsch-TimeDomainAllocationList2) (No) (or pdsch-ConfigCommonRedCap itself is not configured (−)), the terminal apparatus 1 may determine that the resource allocation table to be applied to the PDSCH time domain resource allocation is the default table. Note that the default table A (Default A), the default table B (Default B), or the default table C (Default C) may be determined based on the multiplexing pattern of the SS/PBCH block and the CORESET. Regardless of whether pdsch-ConfigCommon received on the SIB1/another SIB and/or an RRC message received by the terminal apparatus 1 includes or does not include pdsch-TimeDomainAllocationList (pdsch-TimeDomainAllocationList1) (Yes/No), in a case that pdsch-ConfigCommonRedCap received on the SIB1/another SIB and/or an RRC message received by the terminal apparatus 1 includes pdsch-TimeDomainAllocationList (pdsch-TimeDomainAllocationList2) (Yes), the terminal apparatus 1 may determine that the resource allocation table to be applied to the PDSCH time domain resource allocation is the pdsch-TimeDomainAllocationList2. In other words, the terminal apparatus 1 may apply pdsch-TimeDomainAllocationList included in pdsch-ConfigCommonRedCap to determination of the PDSCH time domain resource allocation. In a case that pdsch-ConfigCommon received on the SIB1/another SIB and/or an RRC message received by the terminal apparatus 1 includes pdsch-TimeDomainAllocationList (pdsch-TimeDomainAllocationList1) (Yes), and pdsch-ConfigCommonRedCap received on the SIB1/another SIB and/or an RRC message received by the terminal apparatus 1 does not include pdsch-TimeDomainAllocationList (pdsch-TimeDomainAllocationList2) (No) (or pdsch-ConfigCommonRedCap itself is not configured (−)), the terminal apparatus 1 may determine that the resource allocation table to be applied to the PDSCH time domain resource allocation is the pdsch-TimeDomainAllocationList1. In other words, the terminal apparatus 1 may apply pdsch-TimeDomainAllocationList included in pdsch-ConfigCommon to determination of the PDSCH time domain resource allocation.

As example C in FIG. 10, in a case that the terminal apparatus 1 detects DCI in the type 0 common search space and a CRC scrambled with the SI-RNTI is added to the detected DCI, the terminal apparatus 1 may determine the resource allocation table to be applied to the PDSCH scheduled by the DCI. In a case that a CRC scrambled with the SI-RNTI is added to the detected DCI and pdsch-TimeDomainAllocationList1 is provided in the SIB, the terminal apparatus 1 may apply the default table (for example, the default table A (Default A), the default table B (Default B), or the default table C (Default C)) to the PDSCH time domain resource allocation configuration, regardless of whether pdsch-TimeDomainAllocationList2 is provided. In a case that a CRC scrambled with the SI-RNTI is added to the detected DCI, the terminal apparatus 1 may determine whether to apply the default table A (Default A), apply the default table B (DefaultB), or apply the default table C (Default C) to the PDSCH time domain resource allocation configuration, based on the multiplexing pattern of the SS/PBCH block and the CORESET.

One example of a criterion for applying pdsch-TimeDomainAllocationList2 to the PDSCH time domain resource allocation configuration is whether a corresponding PDSCH can be transmitted/received in the separate initial downlink BWP. For example, as a fifth column in the table illustrated in FIG. 10, whether pdsch-TimeDomainAllocationList (pdsch-TimeDomainAllocationList2) is included in PDSCH-ConfigCommonRedCap is described as a condition; however, in a case that a corresponding PDSCH cannot be transmitted/received in the separate initial downlink BWP, a table in which the fifth column in FIG. 10 is not present may be applied. In other words, in a case that a corresponding PDSCH cannot be transmitted/received in the separate initial downlink BWP, one of pdsch-TimeDomainAllocationList1 and the default table may be applied based on whether PDSCH-ConfigCommon includes pdsch-TimeDomainAllocationList (pdsch-TimeDomainAllocationList1) as a criterion for selecting the parameter list and/or the default table to be applied to the PDSCH time domain resource allocation configuration. Note that “a corresponding PDSCH cannot be transmitted/received in the separate initial downlink BWP” may mean that the CORESET associated with the CSS is not allocated in the separate initial downlink BWP as the CORESET for reception of the DCI for scheduling the PDSCH.

In this manner, owing to a determination method for the parameter list and/or the default table to be applied to the PDSCH time domain resource allocation configuration being different depending on the RNTI for scrambling the CRC to be added to the DCI for scheduling the PDSCH, appropriate time resources can be configured for each piece of information to be transmitted on the PDSCH. For example, in a case that pdsch-TimeDomainAllocationList2 defines appropriate time resources for the PDSCH to be transmitted in the separate initial downlink BWP, and the PDSCH corresponding to a prescribed RNTI is not transmitted in the separate initial downlink BWP, a determination method not including pdsch-TimeDomainAllocationList2 as a candidate may be used, whereas in a case that the PDSCH corresponding to a prescribed RNTI can be transmitted in the separate initial downlink BWP, a determination method including pdsch-TimeDomainAllocationList2 as a candidate may be used. For example, one of the default table A, the default table B, and the default table C may be applied to the PDSCH time domain resource allocation configuration of the PDSCH corresponding to the SI-RNTI, and one of pdsch-TimeDomainAllocationList1, pdsch-TimeDomainAllocationList2, and the default table A may be applied to the PDSCH time domain resource allocation configuration of the PDSCH corresponding to the RA-RNTI, based on the conditions described above.

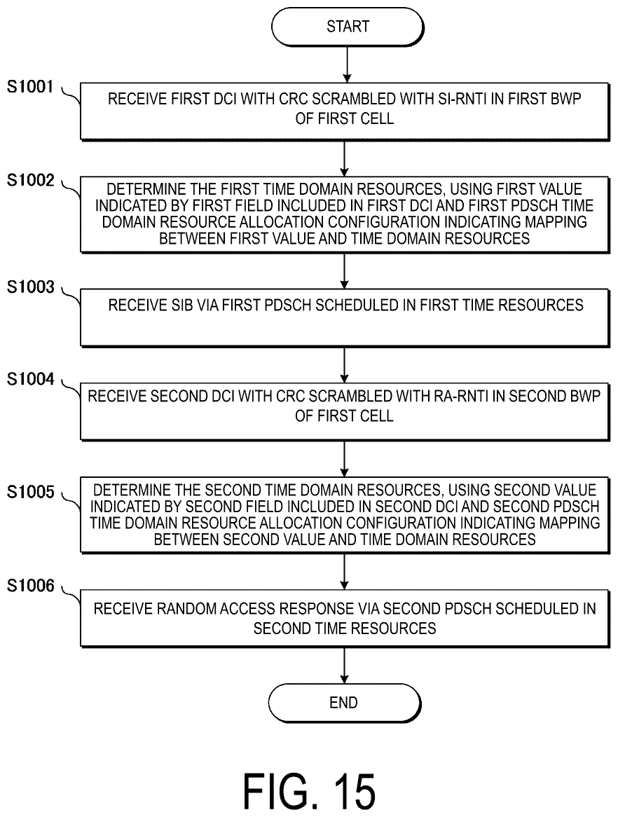

FIG. 15 is a flowchart illustrating an example of processing related to reception of the DCI, the SIB, and the random access response in the terminal apparatus 1 according to the present embodiment. In Step S1001 of FIG. 15, the terminal apparatus 1 receives first DCI with a CRC scrambled with an SI-RNTI in a first BWP of a first cell. In Step S1002, the terminal apparatus 1 determines first time domain resources, using a first value indicated by a first field included in the first DCI and a first PDSCH time domain resource allocation configuration indicating mapping between the first value and time domain resources. In Step S1003, the terminal apparatus 1 receives a SIB via a first PDSCH scheduled in first time resources. In a case that configuration information of a second BWP is included in the SIB, the terminal apparatus 1 that has received the SIB can specify the second BWP. In Step S1004, the terminal apparatus 1 receives second DCI with a CRC scrambled with an RA-RNTI in the second BWP of the first cell. In Step S1005, the terminal apparatus 1 determines second time domain resources, using a second value indicated by a second field included in the second DCI and a second PDSCH time domain resource allocation configuration indicating mapping between the second value and time domain resources. In Step S1006, the terminal apparatus 1 receives a random access response (RAR) via a second PDSCH scheduled in second time resources. Note that, in Step S1002, the terminal apparatus 1 may apply a first default table, a second default table, or a third default table to the first PDSCH time domain resource allocation configuration. Note that, in Step S1005, the terminal apparatus 1 judges whether a second parameter list is provided in the SIB, and in a case that the second parameter list is provided in the SIB, the terminal apparatus 1 may apply the second parameter list to the second PDSCH time domain resource allocation configuration, and in a case that the second parameter list is not provided in the SIB, the terminal apparatus 1 may apply a first parameter list or the first default table to the second PDSCH time domain resource allocation configuration. The flow of the flowchart illustrated in FIG. 15 can be similarly applied to processing related to transmission of the DCI, the SIB, and the random access response in the base station apparatus 3 as well. Note that reception of the first DCI in Step S1001, reception of the SIB in Step S1003, reception of the second DCI in Step S1004, and reception of the random access response in Step S1006 correspond to transmission of the first DCI, transmission of the SIB, transmission of the second DCI, and transmission of the random access response, respectively.

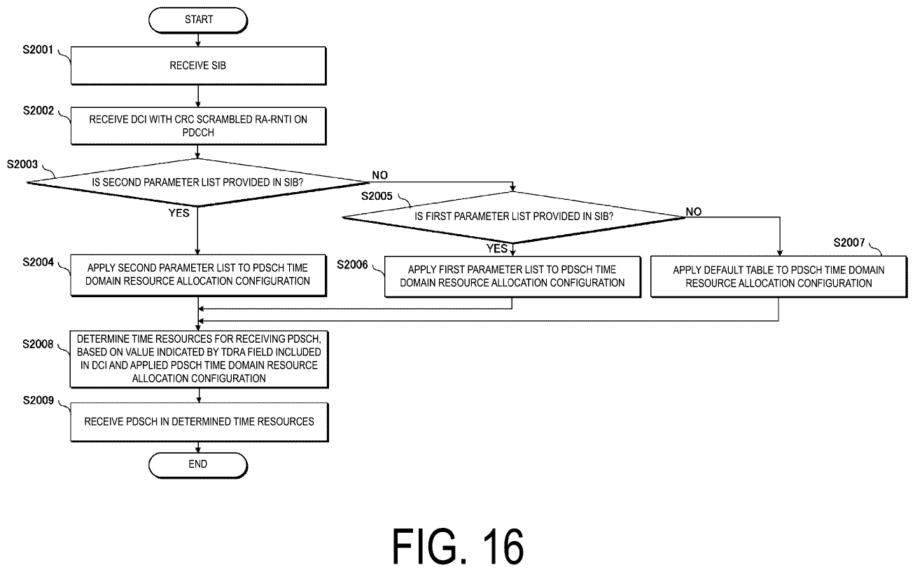

FIG. 16 is a flowchart illustrating an example of processing related to determination/specification/configuration/setting of the resource allocation table to be applied to the PDSCH time domain resource allocation in the terminal apparatus 1 according to the present embodiment. In Step S2001 of FIG. 16, the terminal apparatus 1 receives a SIB (which may be the SIB1). The SIB may include configuration information (which may be initialDownlinkBWP) of a first BWP (which may be the initial downlink BWP), PDSCH configuration information (which may be PDSCH-ConfigCommon) of the first BWP, configuration information (which may be separateInitialDownlinkBWP) of a second BWP (which may be the separate initial downlink BWP), and/or PDSCH configuration information (which may be PDSCH-ConfigCommonRedCap) of the second BWP. In Step S2002, the terminal apparatus 1 receives DCI with a CRC scrambled with an RA-RNTI on a PDCCH. In Step S2003, the terminal apparatus 1 determines whether or not a second parameter list (which may be pdsch-TimeDomainAllocationList2) is provided in the SIB received in Step S2001. In a case that Step S2003 is true (S2003—Yes), in Step S2004, the terminal apparatus 1 applies the second parameter list to a PDSCH time domain resource allocation configuration, and proceeds to Step S2008. In a case that Step S2003 is false (S2003—No), in Step S2005, the terminal apparatus 1 determines whether or not a first parameter list (which may be pdsch-TimeDomainAllocationList1) is provided in the SIB received in Step 2001. In a case that Step S2005 is true (S2005—Yes), in Step S2006, the terminal apparatus 1 applies the first parameter list to the PDSCH time domain resource allocation configuration, and proceeds to Step S2008. In a case that Step S2005 is false (S2005—No), in Step S2007, the terminal apparatus 1 applies a default table to the PDSCH time domain resource allocation configuration, and proceeds to Step S2008. In Step S2008, the terminal apparatus 1 determines time resources for receiving a PDSCH, based on a value indicated by a TDRA field included in received DCI and the applied PDSCH time domain resource allocation configuration. In Step S2009, the terminal apparatus 1 receives the PDSCH in the time resources determined in Step S2008. The flow of the flowchart illustrated in FIG. 16 can be similarly applied to processing related to determination/specification/configuration/setting of the resource allocation table to be applied to the PDSCH time domain resource allocation in the base station apparatus 3 as well. Note that reception of the SIB in Step S2001, reception of the DCI in Step S2002, and reception of the PDSCH in Step S2009 correspond to transmission of the SIB, transmission of the DCI, and transmission of the PDSCH, respectively.

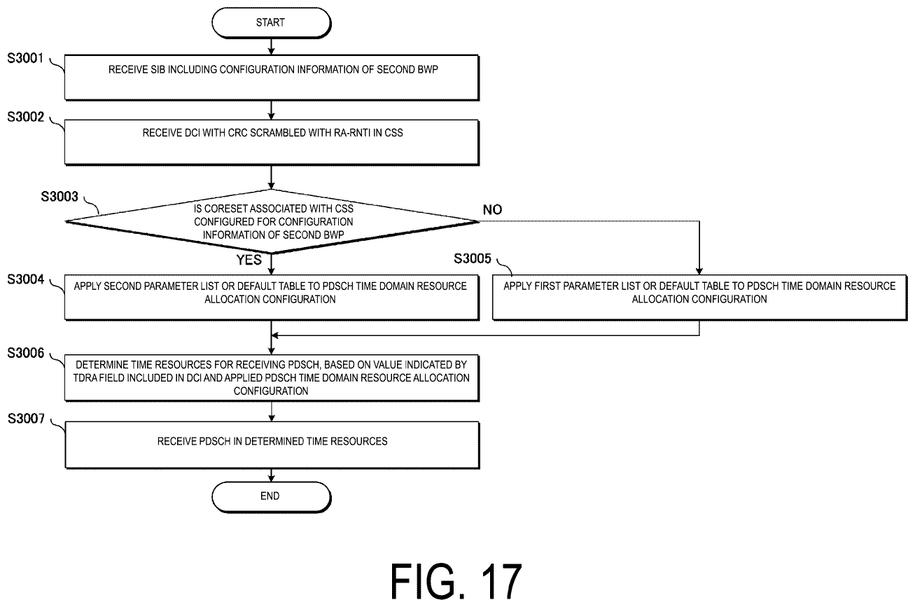

FIG. 17 is another flowchart illustrating an example of processing related to determination/specification/configuration/setting of the resource allocation table to be applied to the PDSCH time domain resource allocation in the terminal apparatus 1 according to the present embodiment. In Step S3001 of FIG. 17, the terminal apparatus 1 receives a SIB (which may be the SIB1) including configuration information (which may be separateInitialDownlinkBWP) of a second BWP (which may be the separate initial downlink BWP). The SIB may include configuration information (which may be initialDownlinkBWP) of a first BWP (which may be the initial downlink BWP), PDSCH configuration information (which may be PDSCH-ConfigCommon) of the first BWP, and/or PDSCH configuration information (which may be PDSCH-ConfigCommonRedCap) of the second BWP. In Step S3002, the terminal apparatus 1 receives DCI with a CRC scrambled with an RA-RNTI on a PDCCH in a common search space (CSS). In Step S3003, the terminal apparatus 1 determines whether or not a CORESET associated with the CSS in Step S3002 is configured for the configuration information of the second BWP received in Step S3001. Note that the determination may be performed prior to Step S3002. In a case that Step S3003 is true (S3003—Yes), in Step S3004, the terminal apparatus 1 applies a second parameter list (which may be pdsch-TimeDomainAllocationList2) or a default table (which may be the default table A) to a PDSCH time domain resource allocation configuration, and proceeds to Step S3006. In a case that Step S3003 is false (S3003—No), in Step S3005, the terminal apparatus 1 applies a first parameter list (which may be pdsch-TimeDomainAllocationList1) or the default table (which may be the default table A) to the PDSCH time domain resource allocation configuration, and proceeds to Step S3006. In Step S3006, the terminal apparatus 1 determines time resources for receiving a PDSCH, based on a value indicated by a TDRA field included in received DCI and the applied PDSCH time domain resource allocation configuration. In Step S3007, the terminal apparatus 1 receives the PDSCH in the time resources determined in Step S3006. Note that, in Step 3004, the terminal apparatus 1 may determine whether to apply the second parameter list or apply the default table to the PDSCH time domain resource allocation configuration, depending on a prescribed condition (for example, whether or not the second parameter list is provided in the SIB). Note that, in Step 3005, the terminal apparatus 1 may determine whether to apply the first parameter list or apply the default table to the PDSCH time domain resource allocation configuration, depending on a prescribed condition (for example, whether or not the first parameter list is provided in the SIB). The flow of the flowchart illustrated in FIG. 17 can be similarly applied to processing related to determination/specification/configuration/setting of the resource allocation table to be applied to the PDSCH time domain resource allocation in the base station apparatus 3 as well. Note that reception of the SIB in Step S3001, reception of the DCI in Step S3002, and reception of the PDSCH in Step S3007 correspond to transmission of the SIB, transmission of the DCI, and transmission of the PDSCH, respectively.

The terminal apparatus 1 may select one PDSCH time domain resource allocation configuration in the determined resource allocation table, based on a value indicated in a ‘Time domain resource assignment’ field (TDRA field) included in the DCI scheduling the PDSCH. For example, in a case that the resource allocation table applied to the PDSCH time domain resource allocation is the default table A, a value m indicated in the TDRA field may indicate a row index m+1 in the default table A. In this case, the PDSCH time domain resource allocation is a time domain resource allocation configuration indicated by the row index m+1. The terminal apparatus 1 assumes the time domain resource allocation configuration indicated by the row index m+1, and receives the PDSCH. For example, in a case that the value m indicated in the TDRA field is 0, the terminal apparatus 1 uses a PDSCH time domain resource allocation configuration with the row index 1 in the default table A to identify the resource allocation in the time domain for the PDSCH scheduled by the DCI.

In a case that the resource allocation table applied to the PDSCH time domain resource allocation is a resource allocation table given from pdsch-TimeDomainAllocationList included in pdsch-ConfigCommon or pdsch-ConfigCommonRedCap, the value m indicated in the TDRA field corresponds to the (m+1)th element (entry, row) in the list pdsch-TimeDomainAllocationList. For example, in a case that the value m indicated in the TDRA field is 0, the terminal apparatus 1 may reference the first element (entry) in the list pdsch-TimeDomainAllocationList. For example, in a case that the value m indicated in the TDRA field is 1, the terminal apparatus 1 may reference the second element (entry) in the list pdsch-TimeDomainAllocationList.

However, the parameter configured in the SIB1 may be broadcasted using another SIB (or REDCAP SIB) or may be notified using RRC signalling.

Configurations of apparatuses according to the present embodiment will be described below.

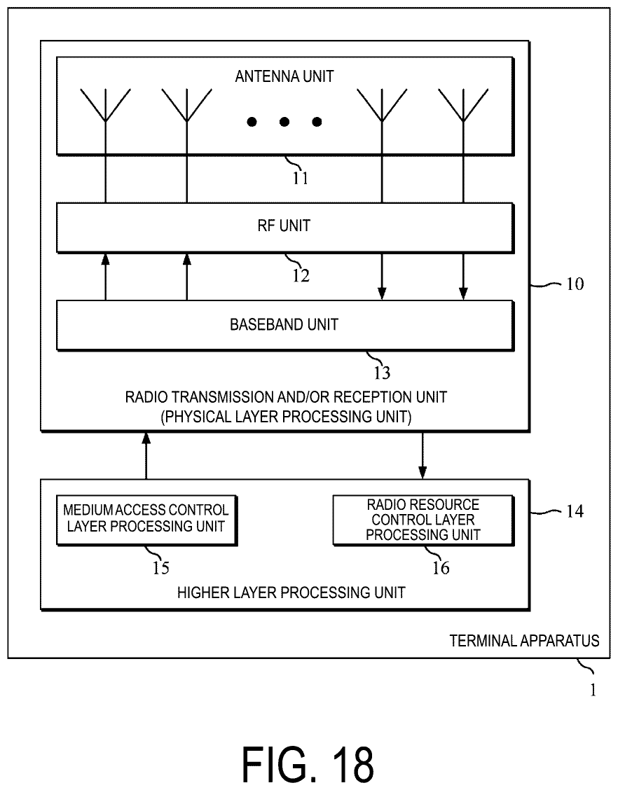

FIG. 18 is a schematic block diagram illustrating a configuration of the terminal apparatus 1 according to the present embodiment. As illustrated in the figure, the terminal apparatus 1 includes a radio transmission and/or reception unit 10 and a higher layer processing unit 14. The radio transmission and/or reception unit 10 includes an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter 10, a receiver 10, a monitor unit 10, or a physical layer processing unit 10. The higher layer processing unit 14 is also referred to as a processing unit 14, a measurement unit 14, a selection unit, 14, a determination unit 14, or a controller 14.

The higher layer processing unit 14 outputs uplink data (that may be referred to as a transport block) generated by a user operation or the like, to the radio transmission and/or reception unit 10. The higher layer processing unit 14 performs a part or all of the processing of the Medium Access Control (MAC) layer, the Packet Data Convergence Protocol (PDCP) layer, the Radio Link Control (RLC) layer, and the Radio Resource Control (RRC) layer. The higher layer processing unit 14 may have a function of acquiring bit information of the MIB (which may be the REDCAP MIB), the SIB1 (which may be the REDCAP SIB1), and other SIBs (which may be the REDCAP SIBs). The higher layer processing unit 14 may have a function of determining/specifying a configuration of an initial downlink BWP (for example, a frequency location or a bandwidth) based on information of the system information block (SIB1/SIB) or the RRC signalling. The higher layer processing unit 14 may have a function of determining/specifying a configuration of an initial uplink BWP (for example, a frequency location or a bandwidth) based on information of the system information block (SIB1/SIB) or the RRC signalling. The higher layer processing unit 14 may have a function of determining/specifying a configuration of a separate initial uplink BWP (for example, a frequency location or a bandwidth) based on information of the system information block (SIB1/SIB) and/or the RRC signalling. The higher layer processing unit 14 may have a function of determining the time resources for receiving the PDSCH, using a value indicated by a field (TDRA field) included in the DCI and the PDSCH time domain resource allocation configuration. The higher layer processing unit 14 may have a function of applying a prescribed parameter list (for example, pdsch-TimeDomainAllocationList1, pdsch-TimeDomainAllocationList2, and/or pdsch-Time DomainAllocationList3) and a prescribed default table (for example, the default table A, the default table B, and/or the default table C) to the PDSCH time domain resource allocation configuration. The higher layer processing unit 14 may have a function of determining the conditions described in an aspect of the present invention (for example, whether or not a prescribed parameter list is provided in a SIB, and/or whether or not the CORESET associated with the CSS is configured in the configuration information (initialDownlinkBWP and/or separateInitialDownlinkBWP) of a prescribed BWP), and determining, as a result of the determination, a parameter list (for example, pdsch-TimeDomainAllocationList1, pdsch-TimeDomainAllocationList2, and/or pdsch-TimeDomainAllocationList3) and/or a default table (for example, the default table A, the default table B, and/or the default table C) to be applied to the PDSCH time domain resource allocation configuration.

The medium access control layer processing unit 15 included in the higher layer processing unit 14 performs processing of the Medium Access Control layer (MAC layer). The medium access control layer processing unit 15 controls transmission of a scheduling request, based on various types of configuration information/parameters managed by the radio resource control layer processing unit 16.

The radio resource control layer processing unit 16 included in the higher layer processing unit 14 performs processing of the Radio Resource Control layer (RRC layer). The radio resource control layer processing unit 16 performs management of various pieces of configuration information/parameters for its apparatus. The radio resource control layer processing unit 16 sets various pieces of configuration information/parameters, based on a higher layer signaling received from the base station apparatus 3. Specifically, the radio resource control layer processing unit 16 sets various pieces of configuration information/parameters, based on information indicating the various pieces of configuration information/parameters received from the base station apparatus 3. The radio resource control layer processing unit 16 controls (identifies) the resource allocation, based on the downlink control information received from the base station apparatus 3.

The radio transmission and/or reception unit 10 performs processing of the physical layer, such as modulation, demodulation, encoding, and decoding. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and encoding data, and transmits the transmit signal to the base station apparatus 3 or the like. The radio transmission and/or reception unit 10 outputs, to the higher layer processing unit 14, the higher layer signaling (RRC message), DCI, and the like received from the base station apparatus 3. The radio transmission and/or reception unit 10 generates and transmits an uplink signal (including a PUCCH and/or a PUSCH), based on an indication from the higher layer processing unit 14. The radio transmission and/or reception unit 10 may have a function of receiving the synchronization signal block, the additional synchronization signal block, the PSS, the SSS, the PBCH, the DMRS for the PBCH, the random access response, the PDCCH, and/or the PDSCH. The radio transmission and/or reception unit 10 may have a function of transmitting a PRACH (which may be a random access preamble), the PUCCH, and/or the PUSCH. The radio transmission and/or reception unit 10 may have a function of monitoring the PDCCH. The radio transmission and/or reception unit 10 may have a function of receiving the DCI on the PDCCH. The radio transmission and/or reception unit 10 may have a function of outputting the DCI received on the PDCCH to the higher layer processing unit 14. The radio transmission and/or reception unit 10 may have a function of receiving the system information block (SIB1 and/or SIB) corresponding to a prescribed cell. The radio transmission and/or reception unit 10 may have a function of receiving the DCI with the CRC scrambled with a prescribed RNTI (for example, the SI-RNTI, the RA-RNTI, the P-RNTI, or the like) in a BWP of a cell. The radio transmission and/or reception unit 10 may have a function of receiving the SIB (which may be the SIB1) or the random access response via the PDSCH scheduled in prescribed time resources in a BWP of a cell.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts a signal in the frequency domain.

The baseband unit 13 generates an OFDM symbol by performing Inverse Fast Fourier Transform (IFFT) on the data, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up converts the analog signal into a signal having a carrier frequency, and transmits the signal via the antenna unit 11. The RF unit 12 amplifies power. Additionally, the RF unit 12 may have a function of determining transmit power for an uplink signal and/or an uplink channel transmitted in the serving cell. The RF unit 12 is also referred to as a transmit power control unit.

The RF unit 12 may use the antenna switch to connect the antenna unit 11 with the filter included in the RF unit 12 in a case of receiving a signal and to connect the antenna unit 11 with the power amplifier included in the RF unit 12 in a case of transmitting a signal.

The RF unit 12 may have a function of tuning/retuning the frequency band applied to the RF circuit in the configured downlink BWP (for example, the initial downlink BWP) in a case that the bandwidth of the configured downlink BWP is wider than the bandwidth supported by the receiver of the terminal apparatus 1 itself (which may be referred to as an allocation bandwidth). However, the frequency band applied to the RF circuit may be a frequency band of a carrier frequency applied in a case of a received signal is down-converted into a baseband signal.

The RF unit 12 may have a function of tuning/retuning the frequency band applied to the RF circuit in the configured uplink BWP (for example, the initial downlink BWP) in a case that the bandwidth of the configured uplink BWP is wider than the bandwidth supported by the transmission of the terminal apparatus 1 itself (which may be referred to as an allocation bandwidth). However, the frequency band applied to the RF circuit may be a frequency band of a carrier frequency applied in a case that an analog signal is up-converted to a carrier frequency.

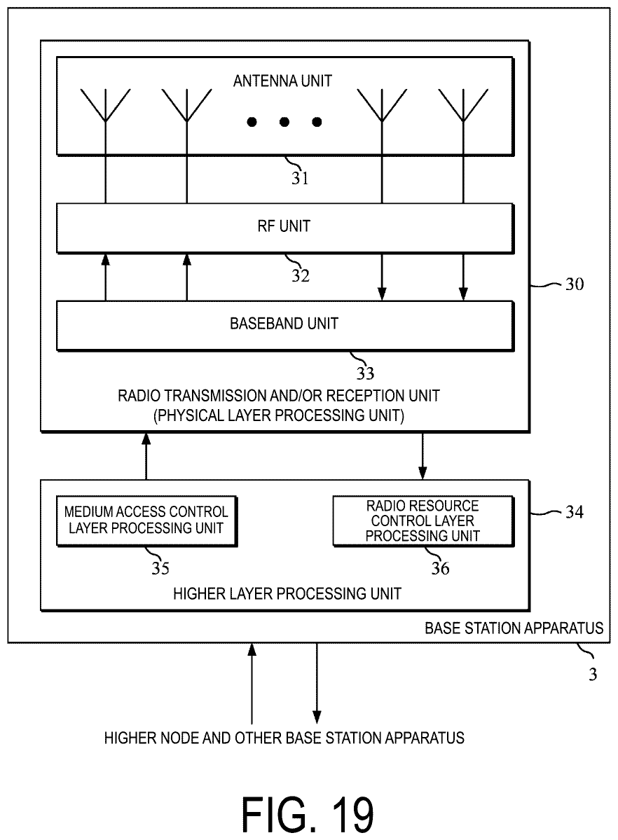

FIG. 19 is a schematic block diagram illustrating a configuration of the base station apparatus 3 according to the present embodiment. As illustrated in the figure, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter 30, a receiver 30, a monitor unit 30, or a physical layer processing unit 30. A controller controlling operations of the units based on various conditions may be separately provided. The higher layer processing unit 34 is also referred to as a processing unit 34, a determination unit 34, or a controller 34.

The higher layer processing unit 34 performs processing for some or all of the Medium Access Control (MAC) layer, the Packet Data Convergence Protocol (PDCP) layer, the Radio Link Control (RLC) layer, and the Radio Resource Control (RRC) layer. The higher layer processing unit 34 may have a function of generating DCI, based on the higher layer signaling transmitted to the terminal apparatus 1 and the time resources for transmitting the PUSCH. The higher layer processing unit 34 may have a function of outputting the generated DCI and the like to the radio transmission and/or reception unit 30. The higher layer processing unit 34 may have a function of generating a system information block (SIB1/SIB) and/or RRC signalling including information for the terminal apparatus 1 to specify the initial downlink BWP. The higher layer processing unit 34 may have a function of generating a system information block (SIB1/SIB) and/or RRC signalling including information for the terminal apparatus 1 to specify the initial uplink BWP. The higher layer processing unit 34 may have a function of determining a value indicated by a field (TDRA field) included in the DCI, using the time resources for transmitting the PDSCH and the PDSCH time domain resource allocation configuration. The higher layer processing unit 34 may have a function of applying a prescribed parameter list (for example, pdsch-TimeDomainAllocationList1, pdsch-TimeDomainAllocationList2, and/or pdsch-TimeDomainAllocationList3) and a prescribed default table (for example, the default table A, the default table B, and/or the default table C) to the PDSCH time domain resource allocation configuration. The higher layer processing unit 34 may have a function of determining the conditions described in an aspect of the present invention (for example, whether or not a prescribed parameter list is provided in a SIB, and/or whether or not the CORESET associated with the CSS is configured in the configuration information (initialDownlinkBWP and/or separateInitialDownlinkBWP) of a prescribed BWP), and determining, as a result of the determination, a parameter list (for example, pdsch-TimeDomainAllocationList1, pdsch-TimeDomainAllocationList2, and/or pdsch-Time DomainAllocationList3) and/or a default table (for example, the default table A, the default table B, and/or the default table C) to be applied to the PDSCH time domain resource allocation configuration.

The medium access control layer processing unit 35 included in the higher layer processing unit 34 performs processing of the MAC layer. The medium access control layer processing unit 35 performs processing associated with a scheduling request, based on various types of configuration information/parameters managed by the radio resource control layer processing unit 36.

The radio resource control layer processing unit 36 included in the higher layer processing unit 34 performs processing of the RRC layer. The radio resource control layer processing unit 36 generates, for the terminal apparatus 1, DCI (uplink grant and downlink grant) including resource allocation information. The radio resource control layer processing unit 36 generates or acquires from a higher node, DCI, downlink data (transport block (TB) and random access response (RAR)) mapped to a PDSCH, system information, an RRC message, a MAC Control Element (CE), and the like, and outputs the generated or acquired data and the like to the radio transmission and/or reception unit 30. The radio resource control layer processing unit 36 performs management of various pieces of configuration information/parameters for each of the terminal apparatuses 1. The radio resource control layer processing unit 36 may set various pieces of configuration information/parameters for each of the terminal apparatuses 1 through a higher layer signaling. Specifically, the radio resource control layer processing unit 36 transmits or broadcasts information indicating the various pieces of configuration information/parameters. The radio resource control layer processing unit 36 may transmit/report information for identifying a configuration of one or multiple reference signals in a cell.

In a case that the base station apparatus 3 transmits the RRC message, the MAC CE, and/or the PDCCH to the terminal apparatus 1, and the terminal apparatus 1 performs processing, based on the reception, the base station apparatus 3 performs processing (control of the terminal apparatus 1 and the system) assuming that the terminal apparatus is performing the above-described processing. In other words, the base station apparatus 3 sends, to the terminal apparatus 1, the RRC message, MAC CE, and/or PDCCH intended to cause the terminal apparatus to perform the processing based on the reception.

The radio transmission and/or reception unit 30 transmits higher layer signaling (RRC message), DCI, and the like to the terminal apparatus 1. The radio transmission and/or reception unit 30 receives the uplink signal transmitted from the terminal apparatus 1 based on an indication from the higher layer processing unit 34. The radio transmission and/or reception unit 30 may have a function of transmitting the PDCCH and/or the PDSCH. The radio transmission and/or reception unit 30 may have a function of receiving one or more PUCCHs and/or PUSCHs. The radio transmission and/or reception unit 30 may have a function of transmitting the DCI on the PDCCH. The radio transmission and/or reception unit 30 may have a function of transmitting the DCI output by the higher layer processing unit 34, on the PDCCH. The radio transmission and/or reception unit 30 may have a function of transmitting the SSB, the PSS, the SSS, the PBCH, and/or the DMRS for the PBCH. The radio transmission and/or reception unit 30 may have a function of transmitting an RRC message (which may be an RRC parameter). The radio transmission and/or reception unit 30 may have a function of transmitting the system information block (SIB1/SIB) by the terminal apparatus 1. The radio transmission and/or reception unit 30 may have a function of transmitting the DCI with the CRC scrambled with a prescribed RNTI (for example, the SI-RNTI, the RA-RNTI, the P-RNTI, or the like) in a BWP of a cell. The radio transmission and/or reception unit 30 may have a function of transmitting the SIB (which may be the SIB1) or the random access response via the PDSCH scheduled in prescribed time resources in a BWP of a cell. In addition, some of the functions of the radio transmission and/or reception unit 30 are similar to the corresponding functions of the radio transmission and/or reception unit 10, and thus description of these functions is omitted. Note that in a case that the base station apparatus 3 is connected to one or multiple transmission reception points 4, some or all of the functions of the radio transmission and/or reception unit 30 may be included in each of the transmission reception points 4.

Further, the higher layer processing unit 34 transmits (transfers) or receives control messages or user data between the base station apparatuses 3 or between a higher network apparatus (MME, S-GW (Serving-GW)) and the base station apparatus 3. Although, in FIG. 19, other constituent elements of the base station apparatus 3, a transmission path of data (control information) between the constituent elements, and the like are omitted, it is apparent that the base station apparatus 3 is provided with multiple blocks, as constituent elements, including other functions necessary to operate as the base station apparatus 3. For example, a Radio Resource Management layer processing unit or an application layer processing unit reside in the higher layer processing unit 34.

Note that “units” in the drawing refer to constituent elements to realize the functions and the procedures of the terminal apparatus 1 and the base station apparatus 3, which are also represented by the terms such as a section, a circuit, a constituting apparatus, a device, a unit, and the like.

Each of the units denoted by the reference sign 10 to the reference sign 16 included in the terminal apparatus 1 may be configured as a circuit. Each of the units denoted by the reference sign 30 to the reference sign 36 included in the base station apparatus 3 may be configured as a circuit.

A program running on an apparatus according to an aspect of the present invention may serve as a program that controls a Central Processing Unit (CPU) and the like to cause a computer to function in such a manner as to realize the functions of the embodiment according to the aspect of the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiment according to an aspect of the present invention may be recorded in a computer-readable recording medium. It may be implemented by causing a computer system to read and perform the program recorded on this recording medium. It is assumed that the “computer system” refers to a computer system built into the apparatuses, and the computer system includes an operating system and hardware components such as a peripheral device. In addition, the “computer-readable recording medium” may be a semiconductor recording medium, an optical recording medium, a magnetic recording medium, a medium dynamically retaining the program for a short time, or any other computer-readable recording medium.

In addition, each functional block or various features of the apparatuses used in the aforementioned embodiments may be implemented or performed on an electric circuit, for example, an integrated circuit or multiple integrated circuits. An electric circuit designed to perform the functions described in the present specification may include a general-purpose processor, a digital signal processor (DSP), an application specific integrated circuit (ASIC), a field programmable gate array (FPGA), or other programmable logic devices, discrete gates or transistor logic, discrete hardware components, or a combination thereof. The general purpose processor may be a microprocessor or may be a processor, a controller, a micro-controller, or a state machine of known type, instead. The aforementioned electric circuit may include a digital circuit or may include an analog circuit. Furthermore, in a case that with advances in semiconductor technology, a circuit integration technology appears that replaces the present integrated circuits, it is also possible to use a new integrated circuit based on the technology according to one or more aspects of the present invention.

Note that, in the embodiments according to an aspect of the present invention, an example has been described in which the present invention is applied to a communication system including a base station apparatus and a terminal apparatus, but the present invention can also be applied in a system in which terminals communicate as in the case of Device to Device (D2D).

Note that the invention of the present application is not limited to the above-described embodiments. Although apparatuses have been described as an example in the embodiment, the invention of the present application is not limited to these apparatuses, and is applicable to a stationary type or a non-movable type electronic apparatus installed indoors or outdoors such as a terminal apparatus or a communication apparatus, for example, an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that do not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B) Terminal apparatus
3 Base station apparatus
4 Transmission reception point (TRP)
10 Radio transmission and/or reception unit
11 Antenna unit
12 RF unit
13 Baseband unit
14 Higher layer processing unit
15 Medium access control layer processing unit
16 Radio resource control layer processing unit
30 Radio transmission and/or reception unit
31 Antenna unit
32 RF unit
33 Baseband unit
34 Higher layer processing unit
35 Medium access control layer processing unit
36 Radio resource control layer processing unit
50 Transmission unit (TXRU)
51 Phase shifter
52 Antenna element

1. A terminal apparatus comprising:
a receiver configured to, in a first BWP of a first cell, receive first downlink control information (DCI) with a CRC scrambled by an SI-RNTI and receive a system information block (SIB) via a first physical downlink shared channel (PDSCH) scheduled in a first time resource, and configured to, in a second BWP of the first cell, receive second DCI with a CRC scrambled by an RA-RNTI and receive a random access response via a second PDSCH scheduled in a second time resource; and
a controller configured to determine the first time resource, using a first value indicated by a first field included in the first DCI and a first PDSCH time domain resource allocation configuration indicating mapping between the first value and a time resource, and determine the second time resource, using a second value indicated by a second field included in the second DCI and a second PDSCH time domain resource allocation configuration indicating mapping between the second value and a time resource, wherein
the controller applies a first default table, a second default table, or a third default table to the first PDSCH time domain resource allocation configuration,
the controller determines whether a second parameter list is provided in the SIB,
in a case that the second parameter list is provided in the SIB, the controller applies the second parameter list to the second PDSCH time domain resource allocation configuration, and
in a case that the second parameter list is not provided in the SIB, the controller applies a first parameter list or the first default table to the second PDSCH time domain resource allocation configuration.

2. The terminal apparatus according to claim 1, wherein
in the case that the second parameter list is not provided in the SIB,
in a case that the first parameter list is provided in the SIB, the controller applies the first parameter list to the second PDSCH time domain resource allocation configuration, and
in a case that the first parameter list is not provided in the SIB, the controller applies the first default table to the second PDSCH time domain resource allocation configuration.

3. The terminal apparatus according to claim 1, wherein
in the case that the second parameter list is not provided in the SIB,
in a case that second configuration information of the second BWP is not provided in the SIB and the first parameter list is provided in the SIB, the controller applies the first parameter list to the second PDSCH time domain resource allocation configuration, and
in a case that the second configuration information is provided in the SIB, the controller applies the first default table to the second PDSCH time domain resource allocation configuration.

4. The terminal apparatus according to claim 1, wherein
the receiver receives information for specifying a frequency location of a control resource set (CORESET) having an index of 0 in a master information block (MIB), and
in a case that the second parameter list is not provided in the SIB, and information for specifying a frequency location of the second BWP is received in the SIB,
in a case that the frequency location of the second BWP includes the frequency location of the CORESET and the first parameter list is provided in the SIB, the controller applies the first parameter list to the second PDSCH time domain resource allocation configuration, and
in a case that the frequency location of the second BWP does not include the frequency location of the CORESET, the controller applies the first default table to the second PDSCH time domain resource allocation configuration.

5. A base station apparatus comprising:
a transmitter configured to, in a first BWP of a first cell, transmit first downlink control information (DCI) with a CRC scrambled by an SI-RNTI and transmit a system information block (SIB) via a first physical downlink shared channel (PDSCH) scheduled in a first time resource, and configured to, in a second BWP of the first cell, transmit second DCI with a CRC scrambled by an RA-RNTI and transmit a random access response via a second PDSCH scheduled in a second time resource; and
a controller configured to determine a first value indicated by a first field included in the first DCI, using the first time resource and a first PDSCH time domain resource allocation configuration indicating mapping between the first value and a time resource, and determine a second value indicated by a second field included in the second DCI, using the second time resource and a second PDSCH time domain resource allocation configuration indicating mapping between the second value and a time resource, wherein
the controller applies a first default table, a second default table, or a third default table to the first PDSCH time domain resource allocation configuration,
in a case that the second parameter list is provided in the SIB, the controller applies the second parameter list to the second PDSCH time domain resource allocation configuration, and
in a case that the second parameter list is not provided in the SIB, the controller applies a first parameter list or the first default table to the second PDSCH time domain resource allocation configuration.

6. The base station apparatus according to claim 5, wherein
in the case that the second parameter list is not provided in the SIB,
in a case that the first parameter list is provided in the SIB, the controller applies the first parameter list to the second PDSCH time domain resource allocation configuration, and
in a case that the first parameter list is not provided in the SIB, the controller applies the first default table to the second PDSCH time domain resource allocation configuration.

7. The base station apparatus according to claim 5, wherein
in the case that the second parameter list is not provided in the SIB,
in a case that second configuration information of the second BWP is not provided in the SIB and the first parameter list is provided in the SIB, the controller applies the first parameter list to the second PDSCH time domain resource allocation configuration, and
in a case that the second configuration information is provided in the SIB, the controller applies the first default table to the second PDSCH time domain resource allocation configuration.

8. The base station apparatus according to claim 5, wherein
the transmitter transmits information for specifying a frequency location of a control resource set (CORESET) having an index of 0 in a master information block (MIB), and
in a case that the second parameter list is not provided in the SIB, and information for specifying a frequency location of the second BWP is transmitted in the SIB,
in a case that the frequency location of the second BWP includes the frequency location of the CORESET and the first parameter list is provided in the SIB, the controller applies the first parameter list to the second PDSCH time domain resource allocation configuration, and
in a case that the frequency location of the second BWP does not include the frequency location of the CORESET, the controller applies the first default table to the second PDSCH time domain resource allocation configuration.

9. A communication method for a base station apparatus, the communication method comprising the steps of:
in a first BWP of a first cell, transmitting first downlink control information (DCI) with a CRC scrambled by an SI-RNTI and transmitting a system information block (SIB) via a first physical downlink shared channel (PDSCH) scheduled in a first time resource, and, in a second BWP of the first cell, transmitting second DCI with a CRC scrambled by an RA-RNTI and transmitting a random access response via a second PDSCH scheduled in a second time resource;
determining a first value indicated by a first field included in the first DCI, using the first time resource and a first PDSCH time domain resource allocation configuration indicating mapping between the first value and a time resource, and determining a second value indicated by a second field included in the second DCI, using the second time resource and a second PDSCH time domain resource allocation configuration indicating mapping between the second value and the time resource;
applying a first default table, a second default table, or a third default table to the first PDSCH time domain resource allocation configuration;
in a case that the second parameter list is provided in the SIB, applying the second parameter list to the second PDSCH time domain resource allocation configuration; and
in a case that the second parameter list is not provided in the SIB, applying a first parameter list or the first default table to the second PDSCH time domain resource allocation configuration.
